(19) United States
(12) Patent Application Publication
(10) Pub. No.: US 2020/0205117 A1
(43) Pub. Date: Jun. 25, 2020

(54) POSITION CALCULATION DEVICE, WIRELESS BASE STATION, POSITION CALCULATION METHOD, AND POSITIONING CONTROL METHOD

(71) Applicant: NTT DOCOMO, INC., Tokyo (JP)

(72) Inventors: Na Yo, Tokyo (JP); Wuri Andarmawanti Hapsari, Tokyo (JP); Shinichi Isobe, Tokyo (JP)

(73) Assignee: NTT DOCOMO, INC., Tokyo (JP)

(21) Appl. No.: 16/637,680

(22) PCT Filed: May 11, 2018
(86) PCT No.: PCT/JP2018/018356

§ 371 Date: Feb. 7, 2020

(30) Foreign Application Priority Data
Aug. 10, 2017 (JP) 2017-155510

(51) Int. Cl. H04W 64/00; H04W 76/15; G01S 5/02; H04W 8/08; H04W 28/02

(52) U.S. Cl. CPC H04W 64/003; H04W 76/15; H04W 28/0268; H04W 8/08; G01S 5/0284

(57) ABSTRACT

This position calculation device for calculating the position of a user terminal that is performing DC is provided with: a transmission unit that transmits, to first wireless base station, accuracy level information indicating the accuracy of positioning of the user terminal based on the type of service; a reception unit that receives, from the first wireless base station, positioning information indicating the result of positioning of the user terminal carried out at the first wireless base station when the accuracy level information indicates a first accuracy level, and receives, from the first wireless base station, positioning information indicating the result of positioning of the user terminal carried out at second wireless base station when the accuracy level information indicates a second accuracy level higher than the first accuracy level; and a position calculation unit that calculates the position of the user terminal by using the positioning information.

### TECHNICAL FIELD

The present invention relates to a position calculation apparatus, a radio base station, a position calculation method, and a positioning control method.

### BACKGROUND ART

In recent years, many applications that provide position information for a user terminal, such as a smartphone or a mobile phone, have been provided. A technique of obtaining the position information of the user terminal may be, for example, positioning of the user terminal by a radio base station. The positioning of the user terminal by the radio base station may be, for example, positioning by OTDOA (Observed Time Difference of Arrival), positioning by ECID (Enhanced Cell ID) or the like (for example, see NPL 1).

3GPP specifies dual connectivity (DC) technique of communicating with multiple radio base stations having different frequencies (for example, see NPL 2).

### CITATION LIST

### Non-Patent Literature

### NPL 1

Iwamura et al. “Further advancement of LTE—LTE Release 9—” NTT DOCOMO Technical Journal, April 2010, vol. 18 No. 1 pp. 48-55

### NPL 2

3GPP TS36.300

### SUMMARY OF INVENTION

### Technical Problem

For 5G, which is the next-generation radio communication system, DC between a 5G radio base station and an LTE (Long Term Evolution) radio base station are discussed. For example, it is studied that the 5G radio base station serves as a small cell base station and covers a narrow area, and the LTE radio base station serves as a macro cell base station and covers a large area.

The radius covered by the macro cell typically ranges from several hundreds of meters to several tens of kilometers. The small cell typically has a low transmission power. In this case, the small cell covers a smaller area than the macro cell does. In such situations, the small cell has a narrower range of identifying the position of the user terminal than the macro cell has. Accordingly, the position information of the user terminal obtained by the small cell has a higher accuracy than that by the macro cell. The accuracy of the position information due to the characteristics of the cell (sometimes referred to as a radio base station) is not limited to that due to the transmission power and/or the size of the cell. For example, a high carrier frequency (3.5 GHz or the like) increases the directionality, which in turn increases the accuracy of the position information.

Unfortunately, in a case where the user terminal implements DC, a technique on whether to cause the radio base station forming the macro cell to position the user terminal or cause the radio base station forming the small cell to position the user terminal, has not been proposed yet.

Accordingly, the present invention has an object to provide a technique of allowing the radio base station in conformity with a required positioning accuracy to position the user terminal, in the case where the user terminal implements DC.

### Solution to Problem

A position calculation apparatus of the present invention is an apparatus that calculates a position of a user terminal in DC (dual connectivity) with a first radio base station and a second radio base station, the position calculation apparatus including: a transmission section that transmits accuracy level information to the first radio base station, the accuracy level information indicating a positioning accuracy of the user terminal based on a type of a service provided for the user terminal; a reception section that receives, from the first radio base station, positioning information indicating a result of positioning of the user terminal performed by the first radio base station when the accuracy level information indicates a first accuracy level, and that receives, from the first radio base station, positioning information indicating a result of positioning of the user terminal performed by the second radio base station when the accuracy level information indicates a second accuracy level having a higher accuracy than the first accuracy level has; and a position calculation section that calculates the position of the user terminal, using the positioning information received by the reception section.

A position calculation apparatus of the present invention is an apparatus that calculates a position of a user terminal in DC (dual connectivity) with a first radio base station and a second radio base station, the position calculation apparatus including: a reception section that receives, from a base station management apparatus, first bearer information indicating that data on the user terminal is passed through the first radio base station, or second bearer information indicating that data on the user terminal is passed through the second radio base station; a transmission section that transmits, to the first radio base station, the first bearer information or the second bearer information received by the reception section; a positioning information reception section that receives, from the first radio base station, positioning information indicating a result of positioning of the user terminal performed by the first radio base station when the first bearer information is transmitted, and receives, from the first radio base station, positioning information indicating a result of positioning of the user terminal performed by the second radio base station when the second bearer information is transmitted; and a position calculation section that calculates the position of the user terminal, using the positioning information received by the positioning information reception section.

A radio base station apparatus of the present invention is a radio base station cooperating with another radio base station to perform DC (dual connectivity) with a user terminal, the radio base station including: a reception section that receives accuracy level information indicating positioning of the user terminal, from a position calculation apparatus that calculates a position of the user terminal; and a transmission section that transmits, to the position calculation apparatus, positioning information indicating a result of positioning of the user terminal performed by the radio base station when the accuracy level information indicates a first accuracy level, and transmits, to the position calculation apparatus, positioning information indicating a result of positioning of the user terminal performed by the other radio base station when the accuracy level information indicates a second accuracy level having a higher accuracy than the first accuracy level has.

A radio base station apparatus of the present invention is a radio base station cooperating with another radio base station to perform DC (dual connectivity) with a user terminal, the radio base station including: a reception section that receives, from a position calculation apparatus that calculates a position of the user terminal, first bearer information indicating that data on the user terminal is passed through the first radio base station, or second bearer information indicating that data on the user terminal is passed through the second radio base station; and a transmission section that transmits, to the position calculation apparatus, positioning information indicating a result of positioning of the user terminal performed by the radio base station when the first bearer information is received, and transmits, to the second radio base station, positioning information indicating a result of positioning of the user terminal performed by the other radio base station when the second bearer information is received.

### Advantageous Effects of Invention

According to the present invention, in the case where the user terminal implements DC, the radio base station in conformity with a required positioning accuracy can position the user terminal.

### BRIEF DESCRIPTION OF DRAWINGS

FIG. 1 illustrates an exemplary configuration of a radio communication system according to Embodiment 1;

FIG. 2 illustrates an example of DC;

FIG. 3 illustrates a schematic operation example of the radio communication system in FIG. 1;

FIG. 4 illustrates an exemplary data configuration of positioning accuracy information;

FIG. 5 illustrates an exemplary block configuration of an LCS server;

FIG. 6 illustrates an exemplary block configuration of MME;

FIG. 7 illustrates an exemplary block configuration of LRF;

FIG. 8 illustrates an exemplary block configuration of eNB;

FIG. 9 illustrates an exemplary block configuration of 5G NR;

FIG. 10 is a sequence diagram illustrating an exemplary operation of the radio communication system;

FIG. 11 is a flowchart illustrating an exemplary operation of the LCS server;

FIG. 12 is a flowchart illustrating an exemplary operation of MME;

FIG. 13 is a flowchart illustrating an exemplary operation of LRF;

FIG. 14 is a flowchart illustrating an exemplary operation of eNB;

FIG. 15 is a flowchart illustrating an exemplary operation of 5G NR;

FIG. 16 illustrates a schematic operation example of a radio communication system according to Embodiment 2;

FIG. 17 illustrates an exemplary data configuration of positioning accuracy information;

FIG. 18 is a sequence diagram illustrating an exemplary operation of the radio communication system;

FIG. 19 illustrates another exemplary data configuration of positioning accuracy information;

FIG. 20 illustrates another exemplary data configuration of positioning accuracy information;

FIG. 21 illustrates a schematic operation example of a radio communication system according to Embodiment 3;

FIG. 22 illustrates an example of QCI information;

FIG. 23 illustrates an exemplary data configuration of the positioning accuracy information;

FIG. 24 is a sequence diagram illustrating an exemplary operation of the radio communication system;

FIG. 25 illustrates a schematic operation example of a radio communication system according to Embodiment 4;

FIG. 26 is a sequence diagram illustrating an exemplary operation of the radio communication system; and

FIG. 27 illustrates an example of hardware configurations of the LCS server, MME, LRF, the radio base station, and the user terminal according to an embodiment of the present invention.

### DESCRIPTION OF EMBODIMENTS

Hereinafter, an embodiment of the present invention will be described with reference to the accompanying drawings.

### Embodiment 1

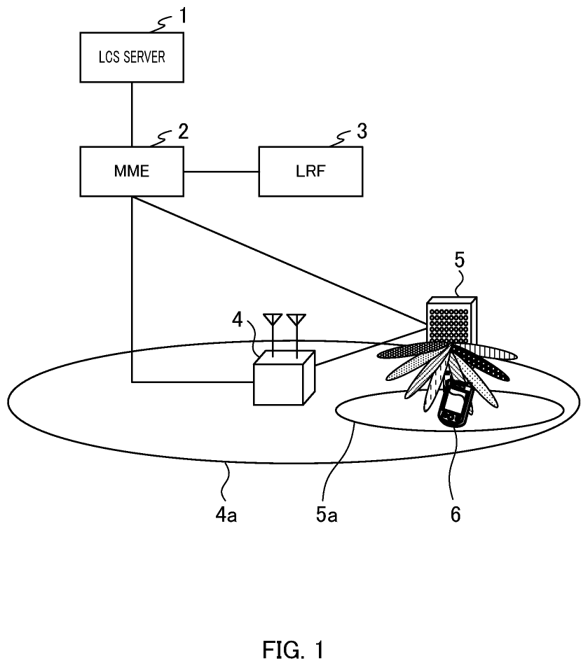

FIG. 1 illustrates an exemplary configuration of a radio communication system according to Embodiment 1. As illustrated in FIG. 1, the radio communication system includes LCS (LoCation Service) server 1, MME (Mobility Management Entity) 2, LRF (Location Retrieval Function) 3, eNB (evolved Node B) 4, 5G NR (5G New Radio) 5, and user terminal 6.

LCS server 1 requests LRF 3 via MME 2 to calculate the position of user terminal 6. After LRF 3 is requested to calculate the position of user terminal 6, the position information of user terminal 6 is returned from LRF 3 to LCS server 1. The position information is, for example, the latitude and longitude of user terminal 6.

MME 2 manages eNB 4 and 5G NR 5. Furthermore, MME 2 manages position registration and calling of user terminal 6, and handover between base stations, for example.

LRF 3 is a position calculation apparatus that calculates the position of user terminal 6. For example, upon receipt of the request for the position information issued by LCS 1, LRF 3 issues a user terminal 6 positioning request to eNB 4.

eNB 4 having received the positioning request issued by LRF 3 issues a positioning request to 5G NR 5, if a predetermined condition is satisfied (hereinafter described in detail). If eNB 4 has issued the positioning request to 5G NR 5, eNB 4 itself does not position user terminal 6. 5G NR 5 having received the positioning request issued by eNB 4 positions user terminal 6.

Meanwhile, eNB 4 having received the positioning request issued by LRF 3 does not issue the positioning request to 5G NR 5 but positions user terminal 6 by itself, if the predetermined condition is not satisfied (hereinafter described in detail). 5G NR 5 having not received the positioning request issued by eNB 4 does not position user terminal 6. That is, user terminal 6 is positioned by only one of eNB 4 and 5G NR 5.

Positioning information of user terminal 6 positioned only one of eNB 4 and 5G NR 5 is transmitted to LRF 3 via MME 2. LRF 3 calculates the position of user terminal 6 on the basis of the positioning information transmitted from any one of eNB 4 and 5G NR 5. LRF 3 then transmits the calculated position (position information) to LCS server 1.

eNB 4 forms a cell 4a that is a macro cell. eNB 4 positions user terminal 6 residing in cell 4a. eNB 4 positions user terminal 6 using ECID, for example.

ECID information positioned by eNB 4 includes, for example, ECGI (E-UTRAN Cell Global Id), RSRP (Reference Signal Received Power), RSRQ (Reference Signal Received Quality), and RX-TX time difference and the like. LRF 3 calculates the position of user terminal 6 from the ECID information including these pieces of information.

Note that LRF 3 can calculate the position of user terminal 6 at least from ECGI included in ECID information. Consequently, in a case where LRF 3 calculates the position of user terminal 6 from ECGI, eNB 4 transmits ECGI to LRF 3 but does not necessarily transmit the other pieces of ECID information to LRF 3. Note that LRF 3 can accurately calculate the position of user terminal 6 using the pieces of ECID information other than ECGI.

5G NR 5 forms cell 5a that is a small cell. 5G NR 5 positions user terminal 6 residing in cell 5a. As with eNB 4, 5G NR 5 positions user terminal 6 using ECID, for example.

eNB 4 and 5G NR 5 form a heterogenous network. Cell 4a formed by eNB 4 and cell 5a formed by 5G NR 5 overlaid with each other. FIG. 1 illustrates one 5G NR 5. However, multiple 5G NRs 5 may reside.

5G NR 5 includes, for example, several tens to several hundreds of antennas, and communicate with user terminal 6. 5G NR 5 controls the amplitude and phase of the signal using the multiple antennas, forms a beam having a directionality to user terminal 6, and transmits and receives the signal. 5G NR 5 can form beams in various directions.

Cell 5a formed by 5G NR 5 is smaller than cell 4a formed by eNB 4. Consequently, the range of identifying user terminal 6 is narrower in the case where 5G NR 5 positions user terminal 6 than in the case where eNB 4 positions user terminal 6. That is, the positioning accuracy of user terminal 6 by 5G NR 5 is higher than the positioning accuracy of user terminal 6 by eNB 4.

User terminal 6 is, for example, a radio terminal, such as a smartphone, a mobile terminal or a tablet terminal. When user terminal 6 is in cell 5a, this terminal can perform DC with eNB 4 and 5G NR 5. When user terminal 6 performs DC, UE Context indicating DC is registered in eNB 4.

Note that LCS server 1 described above may be an apparatus referred to as

EBSCP (External Business user Service Control Point) or GMLC (Gateway Mobile Location Center). eNB 4 may be a radio base station referred to as MeNB (Master eNB). eNB 4 may be a radio base station referred to as LTE base station. 5G NR 5 may be a radio base station referred to as SgNB (Secondary 5G NB). 5G NR 5 may be a radio base station referred to as SeNB (Secondary eNB). Each apparatus is not limited to the apparatus having the name described above. LCS server 1 and LRF 3 may be implemented by one apparatus.

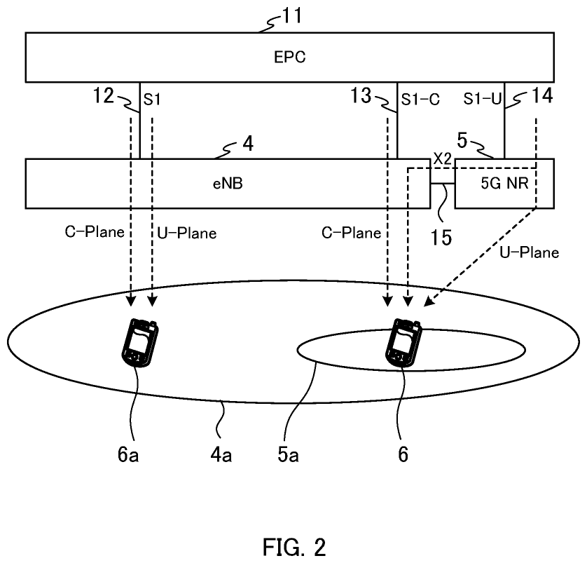

FIG. 2 illustrates an example of DC. In FIG. 2, the same elements as those in FIG. 1 are assigned the same symbols. FIG. 2 illustrates user terminal 6a, EPC (Evolved Packet Core) 11, S1 interface 12, S1-C interface 13, S1-U interface 14, and X2 interface 15. EPC 11 includes LCS server 1, MME 2, and LRF 3, which are illustrated in FIG. 1.

User terminal 6a is in cell 4a formed by eNB 4, but is not in cell 5a formed by 5G NR 5. Consequently, user terminal 6a can perform radio communication with eNB 4 but cannot perform radio communication with 5G NR 5.

User terminal 6 is in cell 4a formed by eNB 4 and in cell 5a formed by 5G NR 5. Consequently, user terminal 6a can perform radio communication (DC) by eNB 4 and 5G NR 5.

As illustrated in FIG. 2, eNB 4 and EPC 11 are connected with each other via S1 interface 12. eNB 4 and EPC 11 are connected with each other via S1-C interface 13. 5G NR 5 and EPC 11 are connected with each other via S1-U interface 14. eNB 4 and 5G NR 5 communicate with each other via X2 interface.

C-Planes of user terminals 6 and 6a are provided for eNB 4 via S1 interface 12 and S1-C interface 13. That is, C-Planes of user terminals 6 and 6a are provided for user terminals 6 and 6a by eNB 4.

U-Plane of user terminal 6a is provided for eNB 4 via S1 interface 12. That is, U-Plane of user terminal 6a is provided for user terminal 6a by eNB 4.

U-Plane of user terminal 6 is provided for 5G NR via S1-U interface 14. U-Plane of user terminal 6 is provided for eNB 4 via X2 interface 15. That is, U-Plane of user terminal 6 is provided for user terminal 6 by both of eNB 4 and 5G NR 5.

Note that the interface connecting eNB 4 and 5G NR 5 to each other may sometimes be referred to as Xn interface. In the following description, the interface connecting eNB 4 and 5G NR 5 to each other may sometimes be referred to as X2/Xn interface. Each interface is not limited to have the above name. That is, “n” of Xn is a tentative name. In the present specification, the name of the interface established between 5G NR, that is, 5G radio base station (SgNB or the like), and another radio base station, is tentatively referred to as Xn interface. Only if the function is equivalent, another name may be adopted.

Incidentally, the accuracy of the position information of the user terminal is different according to the required service. For example, it is assumed that VoLTE service is provided through LTE, and the service of Imadoko search (R) is provided through 5G.

VoLTE is a calling service. Accordingly, the information may be position information positioned by an LTE radio base station. On the other hand, Imadoko search is a service for identifying the location of a child. Accordingly, this service requires highly accurate position information.

However, in a case where the user terminal performs DC with the LTE radio base station and 5G radio base station, a technique for determining which radio base station is to position the user terminal, has not been proposed yet.

In the radio communication system illustrated in FIG. 1, in a case where user terminal 6 performs DC communication with eNB 4 and 5G NR 5, user terminal 6 is configured to be capable of measurement also in 5G NR 5.

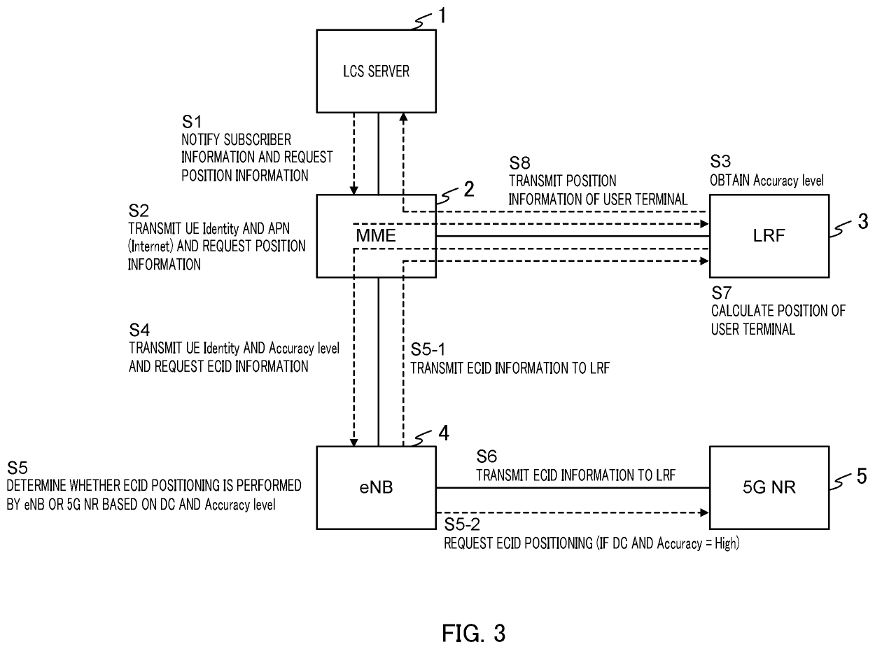

FIG. 3 illustrates a schematic operation example of the radio communication system in FIG. 1. In FIG. 3, the same elements as those in FIG. 1 are assigned the same symbols.

LCS server 1 requests position information of user terminal 6 from MME 2 (step S1). To request the position information, LCS server 1 transmits identification information for identifying user terminal 6 (UE Identity), APN (Access Point Name) of user terminal 6, and LCS information, to MME 2.

The identification information for identifying user terminal 6 may be the subscriber identifier of user terminal 6 (IMSI: International Mobile Subscriber Identity). Alternatively, the identification information for identifying user terminal 6 may be the UE identifier (IMEI: International Mobile Equipment Identity).

APN is an identifier for identifying an external network, such as an ISP (Internet Service Provider) or an enterprise LAN (Local Area Network). User terminal 6 can be connected to another network from a radio network via an access point indicated by APN.

The LCS information is information on a service that requests the position information, and includes, for example, LCS-Client Name, LCS-Client Type, LCS-QoS and the like. LCS-Client Name is the name of ISP or an enterprise user that requests the position information. LCS-Client Type is the type of ISP or an enterprise user that requests the position information. LCS-QoS is information indicating the accuracy of the requested position information.

Next, upon receipt of the request for the position information issued by LCS server 1, MME 2 requests the position information of user terminal 6 from LRF 3 (step S2). To request the position information, MME 2 transmits UE Identity of user terminal 6 transmitted from LCS server 1 in step S1, and APN of user terminal 6, to LRF 3.

Next, LRF 3 obtains Accuracy Level associated with APN transmitted in step S2 from information that associates APN with Accuracy Level indicating the positioning accuracy of the position (hereinafter sometimes referred to as positioning accuracy information) (step S3). Here, the positioning accuracy information is described.

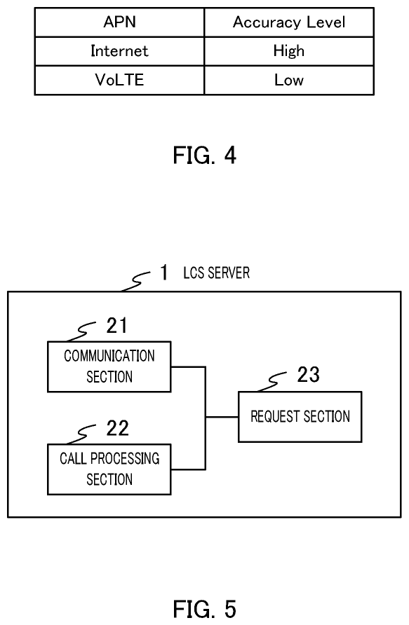

FIG. 4 illustrates an exemplary data configuration of the positioning accuracy information. As illustrated in FIG. 4, the positioning accuracy information associates APN with Accuracy Level. The positioning accuracy information is preliminarily stored in a storage apparatus included in LRF 3, for example.

Accuracy Level indicates the accuracy of the positioned position information of user terminal 6. “High” indicates a higher accuracy of positioned position information than “Low” does.

LRF 3 refers to the positioning accuracy information, and obtains Accuracy Level associated with APN of user terminal 6 transmitted in step S2.

For example, it is assumed that LRF 3 receives APN “Internet” from MME 2. In this case, LRF 3 obtains Accuracy Level “High” from the example in FIG. 4. That is, when APN for user terminal 6 is “Internet,” the position information of user terminal 6 is required to have a high accuracy. In other words, the position information of user terminal 6 is requested for positioning by 5G NR 5 (as described above, 5G NR 5 has a smaller cell and a higher positioning accuracy than eNB 4 has). As described in the following step S5-1, user terminal 6 is sometimes positioned by eNB 4 even if Accuracy Level is “High.”

For example, it is assumed that LRF 3 receives APN “VoLTE” from MME 2. In this case, LRF 3 obtains Accuracy Level “Low” from the example in FIG. 4. That is, when APN for user terminal 6 is “VoLTE,” the position information of user terminal 6 is required to have a low accuracy. In other words, the position information of user terminal 6 is required to be from positioning by eNB 4.

Returning to the description with reference to FIG. 3. Next, LRF 3 transmits UE Identity of user terminal 6 received from MME 2 and Accuracy Level obtained in step S3 to eNB 4 via MME 2 to request ECID information (step S4).

Next, eNB 4 refers to UE Context and determines whether user terminal 6 performs DC or not on the basis of UE Identity transmitted in step S4. eNB 4 determines whether ECID positioning on user terminal 6 is to be performed by eNB 4 or 5G NR 5 on the basis of the DC determination result and Accuracy Level transmitted from LRF 3 in step S4 (step S5).

For example, when eNB 4 determines that user terminal 6 performs DC on the basis of UE Context and Accuracy Level is “High,” eNB 4 determines that 5G NR 5 performs ECID positioning on user terminal 6.

On the other hand, when eNB 4 determines that user terminal 6 does not performs DC on the basis of UE Context, eNB 4 determines that eNB 4 itself performs ECID positioning. This determination is performed because user terminal 6 does not perform DC and is not served by 5G NR 5 accordingly. When eNB 4 determines that user terminal 6 performs DC and Accuracy Level is “Low,” eNB 4 determines that eNB 4 itself performs ECID positioning on user terminal 6. This determination is performed because user terminal 6 is served by 5G NR 5 through DC but is not required for highly accurate measurement.

In step S5, if eNB 4 determines to perform the ECID positioning of user terminal 6, eNB 4 performs the ECID positioning on user terminal 6. eNB 4 transmits the ECID information of user terminal 6 obtained by the ECID positioning to LRF 3 (step S5-1).

On the contrary, if eNB 4 determines that 5G NR 5 performs the ECID positioning on user terminal 6 in step S5, eNB 4 does not perform the ECID positioning on user terminal 6 but issues an ECID positioning request to 5G NR 5 (step S5-2).

Upon receipt of the ECID positioning request issued by eNB 4, 5G NR 5 performs the ECID positioning on user terminal 6. 5G NR 5 then transmits the ECID information of user terminal 6 obtained by the ECID positioning to LRF 3 via eNB 4 and MME 2 (step S5-1).

LRF 3 calculates the position of user terminal 6 on the basis of the ECID information transmitted from eNB 4 in step S5-1 or the ECID information transmitted from 5G NR 5 in step S6 (step S7).

Next, LRF 3 transmits the calculated position (position information) to LCS server 1 via MME 2 (step S8). According to the above process, LCS server 1 requesting the position information of user terminal 6 can obtain the position information of user terminal 6.

FIG. 5 illustrates an exemplary block configuration of LCS server 1. As illustrated in FIG. 5, LCS server 1 includes communication section 21, call processing section 22, and request section 23.

Communication section 21 communicates with another apparatus. Call processing section 22 performs call processing that configures and releases a communication channel.

Request section 23 issues a request for obtaining the position information of user terminal 6 to MME 2. To issue a request for obtaining the position information to MME 2, request section 23 transmits UE Identity of user terminal 6, LCS information, and APN, to MME 2.

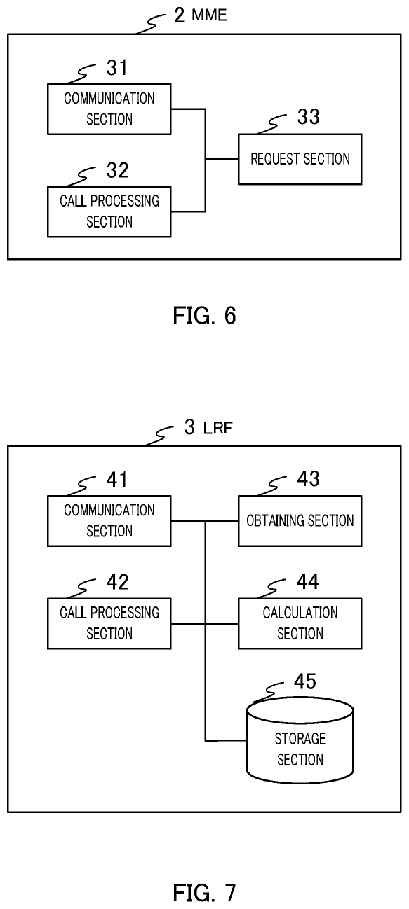

FIG. 6 illustrates an exemplary block configuration of MME 2. As illustrated in FIG. 6, MME 2 includes communication section 31, call processing section 32, and request section 33.

Communication section 31 communicates with another apparatus. Call processing section 32 performs the call processing that configures and releases a communication channel.

Upon receipt of the request for the position information of user terminal 6 from LCS server 1, request section 33 issues a request for obtaining the position information of user terminal 6 to LRF 3. To issue the request for obtaining the position information to LRF 3, request section 33 transmits, to LRF 3, UE Identity and APN of user terminal 6 transmitted from LCS server 1.

FIG. 7 illustrates an exemplary block configuration of LRF 3. As illustrated in FIG. 7, LRF 3 includes communication section 41, call processing section 42, obtaining section 43, calculation section 44, and storage section 45.

Communication section 41 communicates with another apparatus. Call processing section 42 performs the call processing that configures and releases a communication channel.

Upon receipt of the request for obtaining the position information of user terminal 6 from MME 2, obtaining section 43 obtains Accuracy Level of user terminal 6. For example, obtaining section 43 refers to positioning accuracy information (see FIG. 4) stored in storage section 45 on the basis of APN of user terminal 6 transmitted from MME 2 during the request for obtaining the position information, and obtains Accuracy Level of user terminal 6. Obtaining section 43 transmits the obtained Accuracy Level and UE Identity of user terminal 6 transmitted from MME 2 during the request for obtaining the position information, to eNB 4.

Calculation section 44 calculates the position information of user terminal 6 on the basis of the ECID information transmitted from eNB 4. Calculation section 44 calculates the position information of user terminal 6 on the basis of the ECID information transmitted from 5G NR 5. Calculation section 44 calculates the latitude and longitude of user terminal 6 from the received ECID information, for example.

The positioning accuracy information described with reference to FIG. 4 is stored in storage section 45.

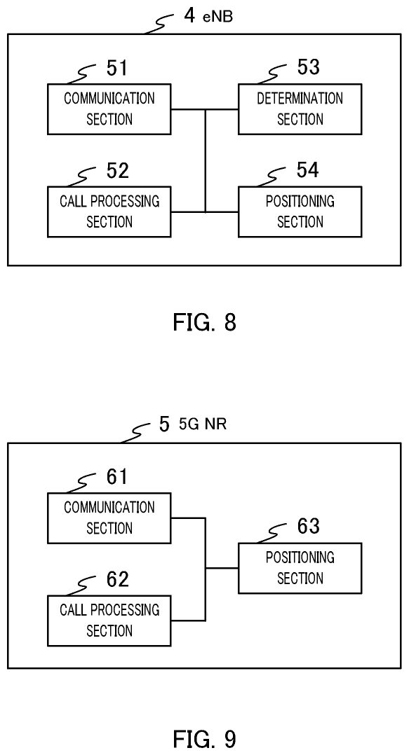

FIG. 8 illustrates an exemplary block configuration of eNB 4. As illustrated in FIG. 8, eNB 4 includes communication section 51, call processing section 52, determination section 53, and positioning section 54.

Communication section 51 communicates with another apparatus. Call processing section 52 performs the call processing that configures and releases a communication channel.

Determination section 53 determines whether to allow eNB 4 to perform the ECID positioning on user terminal 6, or to allow 5G NR 5 to perform the ECID positioning on user terminal 6.

For example, determination section 53 refers to UE Context of user terminal 6 and determines whether user terminal 6 performs DC or not on the basis of UE Identity of user terminal 6 transmitted from MME 2. If determination section 53 determines that user terminal 6 performs DC and Accuracy Level transmitted from MME 2 is “High,” determination section 53 determines that 5G NR 5 is to perform the ECID positioning. If determination section 53 determines that user terminal 6 does not perform DC and Accuracy Level transmitted from MME 2 is not “High,” determination section 53 determines that eNB 4 is to perform the ECID positioning.

If determination section 53 determines that 5G NR 5 is to perform the ECID positioning, 5G NR 5 issues an ECID positioning request to 5G NR 5.

if determination section 53 determines that eNB 4 is to perform the ECID positioning, positioning section 54 performs the ECID positioning on user terminal 6. Positioning section 54 transmits the ECID information of user terminal 6 obtained by the ECID positioning to LRF 3.

FIG. 9 illustrates an exemplary block configuration of 5G NR 5. As illustrated in FIG. 9, 5G NR 5 includes communication section 61, call processing section 62, and positioning section 63.

Communication section 61 communicates with another apparatus. Call processing section 62 performs the call processing that configures and releases a communication channel.

Upon receipt of the ECID positioning request issued by eNB 4, positioning section 63 performs the ECID positioning on user terminal 6. Positioning section 63 transmits the ECID information of user terminal 6 obtained by the ECID positioning to LRF 3 via eNB 4.

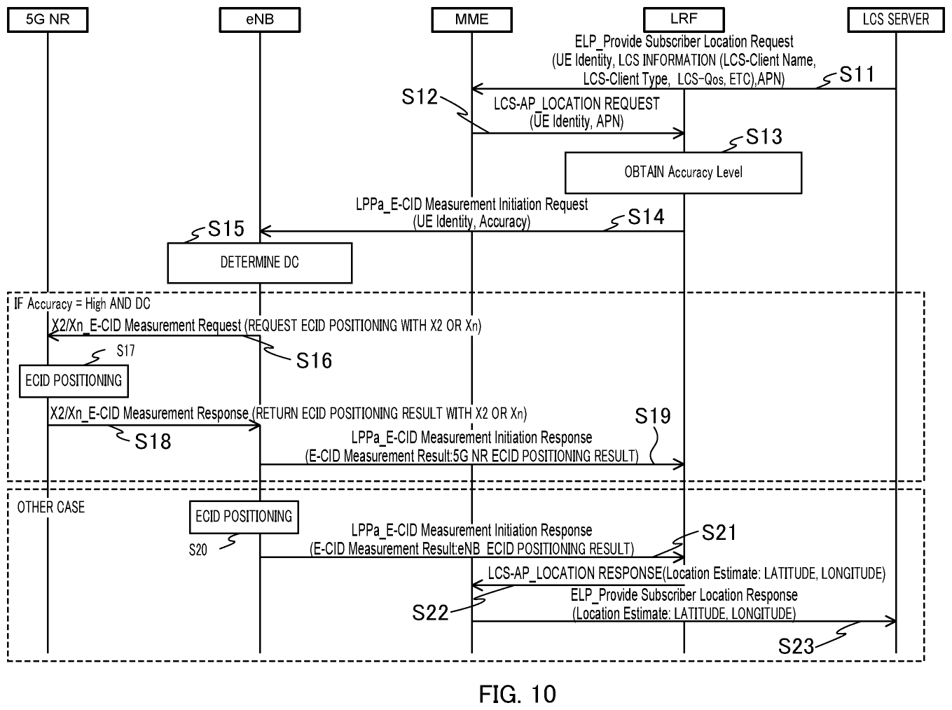

FIG. 10 is a sequence diagram illustrating an exemplary operation of the radio communication system. It is assumed that the positioning accuracy information described with reference to FIG. 4 is stored in storage section 45 of LRF 3.

First, request section 23 of LCS server 1 transmits ELP_Provide Subscriber Location Request to MME 2 via communication section 21 (step S11). That is, request section 23 issues a request for obtaining the position information of user terminal 6 to MME 2. ELP_Provide Subscriber Location Request transmitted to MME 2 includes UE Identity for identifying user terminal 6, LCS information, and APN.

Next, upon receipt of ELP_Provide Subscriber Location Request from LCS server 1 via communication section 31, request section 33 of MME 2 transmits LCS-AP_LOCATION REQUEST to LRF 3 (step S12). That is, request section 33 issues a request for obtaining the position information of user terminal 6 to LRF 3. LCS-AP_LOCATION REQUEST transmitted to LRF 3 includes UE Identity of user terminal 6 included in ELP_Provide Subscriber Location Request, and APN of user terminal 6.

Next, upon receipt of LCS-AP_LOCATION REQUEST from MME 2 via communication section 41, obtaining section 43 of LRF 3 refers to the positioning accuracy information stored in storage section 45 and obtains Accuracy Level of user terminal 6 (step S13).

For example, LCS-AP_LOCATION REQUEST received from MME 2 includes APN of user terminal 6. Obtaining section 43 refers to the positioning accuracy information on the basis of APN of user terminal 6 included in LCS-AP_LOCATION REQUEST, and obtains Accuracy Level of user terminal 6.

More specifically, if APN is “Internet,” obtaining section 43 obtains Accuracy Level “High” (see FIG. 4). If APN is “VoLTE,” obtaining section 43 obtains Accuracy Level “Low” (see FIG. 4).

Next, when obtaining section 43 of LRF 3 obtains Accuracy Level of user terminal 6, LPPa_E-CID Measurement Initiation Request is transmitted to eNB 4 via communication section 41 (step S14). That is, obtaining section 43 issues a request for the ECID information of user terminal 6 to eNB 4. LPPa_E-CID Measurement Initiation Request transmitted to eNB 4 includes Accuracy Level obtained by obtaining section 43 in step S13, and UE Identity of user terminal 6 included in LCS-AP_LOCATION REQUEST received in step S12.

Next, determination section 53 of eNB 4 determines whether user terminal 6 performs DC or not (step S15).

For example, LPPa_E-CID Measurement Initiation Request received from LRF 3 includes UE Identity of user terminal 6. Determination section 53 refers to UE Context of user terminal 6 and determines whether user terminal 6 performs DC or not on the basis of UE Identity included in LPPa_E-CID Measurement Initiation Request.

Next, if determination section 53 of eNB 4 determines that user terminal 6 performs DC in step S15 and Accuracy Level included in LPPa_E-CID Measurement Initiation Request received from LRF 3 is “High,” eNB 4 transmits X2/Xn_E-CID Measurement Request to 5G NR 5 (step S16). That is, determination section 53 issues an ECID positioning request to 5G NR 5. X2/Xn_E-CID Measurement Request transmitted to 5G NR 5 includes UE Identity of user terminal 6 included in LPPa_E-CID Measurement Initiation Request.

Upon receipt of X2/Xn_E-CID Measurement Request from eNB 4 via communication section 61, positioning section 63 of 5G NR 5 performs ECID positioning on user terminal 6 (step S17).

For example, X2/Xn_E-CID Measurement Request received from eNB 4 includes UE Identity of user terminal 6. Positioning section 63 performs ECID positioning on the cell served by the context of UE Identity of user terminal 6.

Next, when positioning section 63 of 5G NR 5 obtains the ECID information of user terminal 6, this section transmits X2/Xn_E-CID Measurement Response to eNB 4 via communication section 61 (step S18). That is, positioning section 63 returns the positioning result of ECID for user terminal 6 to eNB 4.

Next, upon receipt of the ECID information of user terminal 6 (ECID positioning result) from 5G NR 5, communication section 51 of eNB 4 transmits LPPa_E-CID Measurement Initiation Response to LRF 3 (step S19). LPPa_E-CID Measurement Initiation Response transmitted to LRF 3 includes E-CID Measurement Result, which is the ECID positioning result on user terminal 6.

If determination section 53 of eNB 4 determines that user terminal 6 does not perform DC in step S15 or Accuracy Level transmitted in step S14 is “Low,” positioning section 54 of eNB 4 performs the ECID positioning on user terminal 6 (step S20). Positioning section 54 then transmits LPPa_E-CID Measurement Initiation Response to LRF 3 via communication section 51 (step S21). LPPa_E-CID Measurement Initiation Response transmitted to LRF 3 includes E-CID Measurement Result, which is the ECID positioning result on user terminal 6.

Calculation section 44 of LRF 3 receives, via communication section 41, LPPa_E-CID Measurement Initiation Response transmitted in step S19. Calculation section 44 of LRF 3 receives, via communication section 41, LPPa_E-CID Measurement Initiation Response transmitted in step S21. Calculation section 44 calculates the latitude longitude of user terminal 6 on the basis of the received LPPa_E-CID Measurement Initiation Response. Calculation section 44 then transmits LCS-AP_LOCATION RESPONSE to MME 2 via communication section 41 (step S22). LCS-AP_LOCATION RESPONSE transmitted to MME 2 includes the latitude and longitude calculated by calculation section 44.

Upon receipt of LCS-AP_LOCATION RESPONSE transmitted from LRF 3, communication section 31 of MME 2 transmits ELP_Provide Subscriber Location Response to LCS server 1 (step S23). ELP_Provide Subscriber Location Response transmitted to LCS server 1 includes the latitude and longitude of user terminal 6 calculated by calculation section 44 of LRF 3. According to the above processing, the position information of user terminal 6 is obtained according to APN of user terminal 6 by any one of eNB 4 and 5G NR 5. The obtained position information is transmitted to LCS server 1 having requested the position information.

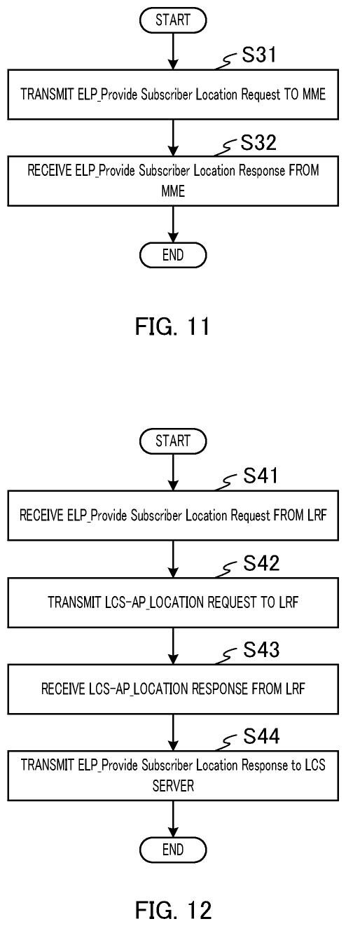

FIG. 11 is a flowchart illustrating an exemplary operation of LCS server 1. First, request section 23 transmits ELP_Provide Subscriber Location Request to MME 2 via communication section 21 (step S31). ELP_Provide Subscriber Location Request transmitted to MME 2 includes UE Identity on user terminal 6 whose position information is requested, LCS information, and APN.

After ELP_Provide Subscriber Location Request is transmitted to MME 2, ELP_PROVIDE SUBSCRIBER LOCATION RESPONSE is required from MME 2 (see step S44 in FIG. 12). Request section 23 receives, via communication section 21, ELP_PROVIDE SUBSCRIBER LOCATION RESPONSE returned from MME 2 (step S32). The received ELP_PROVIDE SUBSCRIBER LOCATION RESPONSE includes the latitude and longitude of user terminal 6 whose position information is requested. According to the above process, LCS server 1 can obtain the position information of user terminal 6.

FIG. 12 is a flowchart illustrating an exemplary operation of MME 2. First, request section 33 receives, via communication section 31, ELP_Provide Subscriber Location Request transmitted from LRF 3 (see step S31 in FIG. 11) (step S41). The received ELP_Provide Subscriber Location Request includes UE Identity on user terminal 6 whose position information is requested, LCS information, and APN.

Next, request section 33 transmits LCS-AP_LOCATION RESPONSE to LRF 3 via communication section 31 (step S42). LCS-AP_LOCATION REQUEST transmitted to LRF 3 includes APN received in step S41, and UE Identity of user terminal 6.

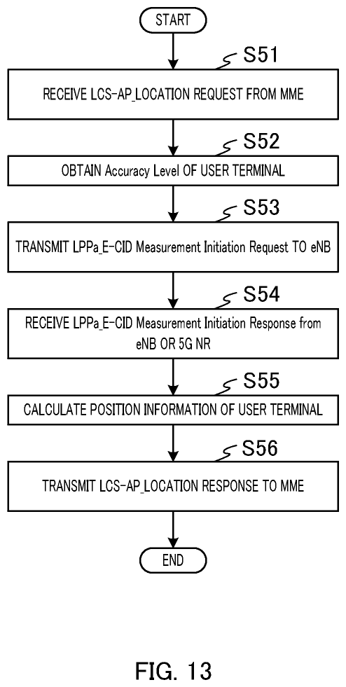

After LCS-AP_LOCATION REQUEST is transmitted to LRF 3, LCS-AP_LOCATION RESPONSE is returned from LRF 3 (see step S56 in FIG. 13). Request section 33 receives, via communication section 31, LCS-AP_LOCATION RESPONSE returned from LRF 3 (step S43). LCS-AP_LOCATION RESPONSE returned from LRF 3 includes the position information of user terminal 6.

Upon receipt of LCS-AP_LOCATION REQUEST in step S43, request section 33 transmits ELP_Provide Subscriber Location Response to LCS server 1 (step S44). ELP_Provide Subscriber Location Response transmitted to LCS server 1 includes the position information of user terminal 6 received in step S43. According to the above process, LCS server 1 can obtain the position information of user terminal 6.

FIG. 13 is a flowchart illustrating an exemplary operation of LRF 3. First, communication section 41 receives LCS-AP_LOCATION REQUEST (see step S42 in FIG. 12) transmitted from MME 2 (step S51). The received LCS-AP_LOCATION REQUEST includes APN for user terminal 6, and UE Identity of user terminal 6.

Next, obtaining section 43 refers to storage section 45 on the basis of APN included in LCS-AP_LOCATION REQUEST received in step S51, and obtains Accuracy Level of user terminal 6 (step S52).

Next, obtaining section 43 transmits LPPa_E-CID Measurement Initiation Request to eNB 4 via communication section 41 (step S53). LPPa_E-CID Measurement Initiation Request transmitted to eNB 4 includes Accuracy Level of user terminal 6 obtained in step S52, and UE Identity of user terminal 6 received in step S51.

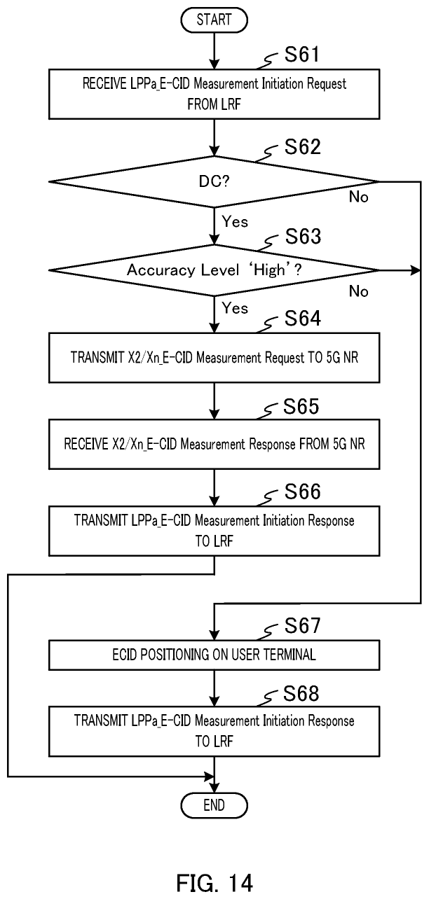

After LPPa_E-CID Measurement Initiation Request is transmitted to eNB 4, LPPa_E-CID Measurement Initiation Response is returned from eNB 4 (see steps S66 and S68 in FIG. 14). Calculation section 44 receives, via communication section 41, LPPa_E-CID Measurement Initiation Response returned from eNB 4 (step S54). LPPa_E-CID Measurement Initiation Response returned from eNB 4 or 5G NR 5 includes the ECID positioning result on user terminal 6.

Next, calculation section 44 calculates the position information of user terminal 6 on the basis of the ECID positioning result on user terminal 6 received in step S54 (step S55).

Next, calculation section 44 transmits LCS-AP_LOCATION RESPONSE to MME 2 via communication section 41 (step S56). LCS-AP_LOCATION RESPONSE transmitted to MME 2 includes the position information of user terminal 6 calculated in step S55. According to the above processing, MME 2 can receive the position information of user terminal 6 from LRF 3, and transmit the information to LCS server 1.

FIG. 14 is a flowchart illustrating an exemplary operation of eNB 4. First, determination section 53 receives, via communication section 51, LPPa_E-CID Measurement Initiation Request (see step S53 in FIG. 13) transmitted from LRF 3 (step S61). The received LPPa_E-CID Measurement Initiation Request includes Accuracy Level of user terminal 6, and UE Identity of user terminal 6.

Determination section 53 refers to UE Context and determines whether user terminal 6 performs DC or not on the basis of UE Identity of user terminal 6 received in step S61 (step S62).

If determination section 53 determines that user terminal 6 performs DC in step S62 (Yes in S62), this section determines whether Accuracy Level is “High” or not (step S63).

If determination section 53 determines that Accuracy Level of user terminal 6 is “High” in step S63 (Yes in S63), X2/Xn_E-CID Measurement Request is transmitted to 5G NR 5 (step S64).

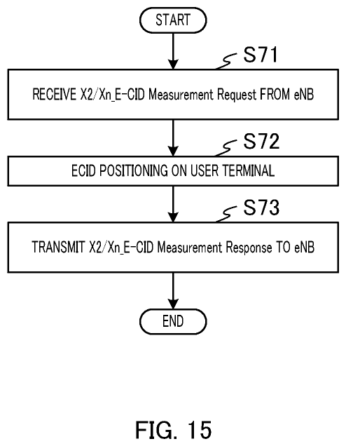

After X2/Xn_E-CID Measurement Request is transmitted to 5G NR 5, X2/Xn_E-CID Measurement Response is returned from 5G NR 5 (see step S73 in FIG. 15). Communication section 51 receives X2/Xn_E-CID Measurement Response returned from 5G NR 5 (step S65). The received X2/Xn_E-CID Measurement Response includes the ECID positioning result on user terminal 6 positioned by 5G NR 5.

When communication section 51 receives X2/Xn_E-CID Measurement Response in step S65, LPPa_E-CID Measurement Initiation Response is transmitted to LRF 3 (step S66). LPPa_E-CID Measurement Initiation Response transmitted to LRF 3 includes the ECID positioning result on user terminal 6.

If it is determined that user terminal 6 does not perform DC in step S62 (No in S62) or that Accuracy Level is not “High” in step S63 (No in S63), positioning section 54 performs the ECID positioning on user terminal 6 (step S67).

When positioning section 54 obtains the ECID information of user terminal 6, LPPa_E-CID Measurement Initiation Response is transmitted to LRF 3 via communication section 51 (step S68). LPPa_E-CID Measurement Initiation Response transmitted to LRF 3 includes the ECID positioning result on user terminal 6 obtained by positioning in step S67. According to the above processing, LRF 3 can calculate the position of user terminal 6 from the ECID positioning result on user terminal 6.

FIG. 15 is a flowchart illustrating an exemplary operation of 5G NR 5. First, positioning section 63 receives X2/Xn_E-CID Measurement Request transmitted from eNB 4 via communication section 61 (see step S64 in FIG. 14) (step S71).

Upon receipt of X2/Xn_E-CID Measurement Request from in step S71, positioning section 63 performs ECID positioning on user terminal 6 (step S72).

Next, positioning section 63 transmits X2/Xn_E-CID Measurement Response to eNB 4 via communication section 61 (step S73). X2/Xn_E-CID Measurement Response transmitted to eNB 4 includes the ECID positioning result on user terminal 6 obtained by positioning in step S72. According to the above processing, the ECID positioning result on user terminal 6 is transmitted to eNB 4 and is transmitted to LRF 3.

As described above, LRF 3 refers to the positioning accuracy information and obtains Accuracy Level of user terminal 6 on the basis of APN for user terminal 6. LRF 3 transmits the obtained Accuracy Level to eNB 4. eNB 4 determines whether eNB 4 performs the ECID positioning on user terminal 6 or 5G NR 5 performs the ECID positioning on user terminal 6 on the basis of DC of user terminal 6 and Accuracy Level of user terminal 6 transmitted from LRF 3. If eNB 4 determines that 5G NR 5 is to perform the ECID positioning on user terminal 6, eNB 4 issues an ECID positioning request to 5G NR 5, and 5G NR 5 performs the ECID positioning on user terminal 6. LRF 3 receives the positioning result from any one of eNB 4 and 5G NR 5 having performed ECID positioning, and calculates the position of user terminal 6. According to this configuration, the radio communication system can appropriately position user terminal 6 through any one of eNB 4 and 5G NR 5 according to the required accuracy of the position information.

Note that in the description has been made assuming that Accuracy Level is any of two types, which are “High” and “Low.” However, the types are not limited thereto. For example, Accuracy Level “Middle” or the like may be configured. Note that even if three or more types of Accuracy Level are provided, user terminal 6 is positioned by any of eNB 4 and 5G NR 5.

### Embodiment 2

In Embodiment 1, Accuracy Level of the user terminal is obtained on the basis of APN. In Embodiment 2, Accuracy Level of the user terminal is obtained on the basis of LCS information. Different parts from those in Embodiment 1 are hereinafter described. Note that the configuration of the radio communication system is analogous to that in FIG. 1.

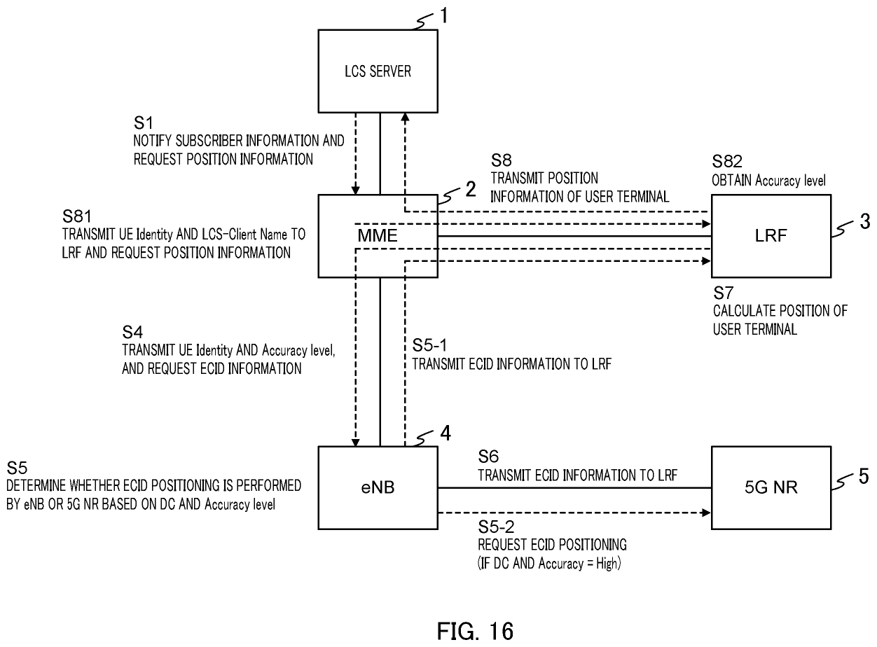

FIG. 16 illustrates a schematic operation example of a radio communication system according to Embodiment 2. The process in step S1 illustrated in FIG. 16 is analogous to that in step S1 illustrated in FIG. 3. That is, LCS server 1 requests the position information of user terminal 6 from MME 2. To request the position information, LCS server 1 transmits UE Identity of user terminal 6, APN of user terminal 6, and the LCS information to MME 2.

Upon receipt of the request for the position information issued by LCS server 1, MME 2 requests the position information of user terminal 6 from LRF 3 (step S81). To request the position information, MME 2 transmits UE Identity of user terminal 6 transmitted from LCS server 1 in step S1, and LCS-Client Name included in the LCS information, to LRF 3.

Next, LRF 3 obtains Accuracy Level associated with LCS-Client Name transmitted in step S81, on the basis of the positioning accuracy information that associates the LCS-Client Name with Accuracy Level indicating the positioning accuracy of the position (step S82). Here, the positioning accuracy information is described.

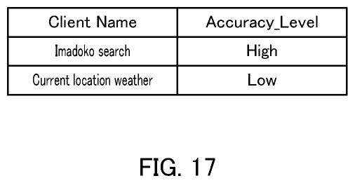

FIG. 17 illustrates an exemplary data configuration of the positioning accuracy information. As illustrated in FIG. 17, the positioning accuracy information associates Client Name with Accuracy Level. Client Name indicates LCS-Client Name of LCS information. The positioning accuracy information is preliminarily stored in storage section 45 included in LRF 3, for example.

Imadoko search is illustrated in Client Name in FIG. 17 is a service for identifying the location of a child. Accordingly, this service requires highly accurate position information. Consequently, Accuracy Level “High” is associated with Client Name of “Imadoko search” illustrated in FIG. 17. Meanwhile, Accuracy Level “Low” is associated with Client Name “Current location weather,” which does not require a highly accurate position information.

LRF 3 refers to the positioning accuracy information, and obtains Accuracy Level associated with LCS-Client Name transmitted in step S81.

For example, it is assumed that LRF 3 receives LCS-Client Name “Imadoko search” from MME 2. In this case, LRF 3 obtains Accuracy Level “High” from the example in FIG. 17. Meanwhile, it is assumed that LRF 3 receives LCS-Client Name “Current location weather” from MME 2. In this case, LRF 3 obtains Accuracy Level “Low” from the example in FIG. 17.

In the processing thereafter, positioning and position calculation of user terminal 6 according to Accuracy Level are performed. That is, the following processes are analogous to the processes in steps S4 to step S8 illustrated in FIG. 3. Accordingly, the description thereof is omitted.

The block configuration of LCS server 1 is analogous to that in FIG. 5. Accordingly, the description thereof is omitted. The block configuration of MME 2 is analogous to that in FIG. 6. However, the function of request section 33 is partially different. To issue a request for obtaining the position information of user terminal 6, request section 33 transmits LCS-Client Name of the LCS information to LRF 3.

The block configuration of LRF 3 is analogous to that in FIG. 7. However, the function of obtaining section 43 is partially different. Obtaining section 43 refers to the positioning accuracy information (see FIG. 17) on the basis of LCS-Client Name of the LCS information transmitted from MME 2, and obtains Accuracy Level of user terminal 6. Storage section 45 of LRF 3 stores the positioning accuracy information that associates Client Name with Accuracy Level.

The block configuration of eNB 4 is analogous to that in FIG. 8. Accordingly, the description thereof is omitted. The block configuration of 5G NR 5 is analogous to that in FIG. 9. Accordingly, the description thereof is omitted.

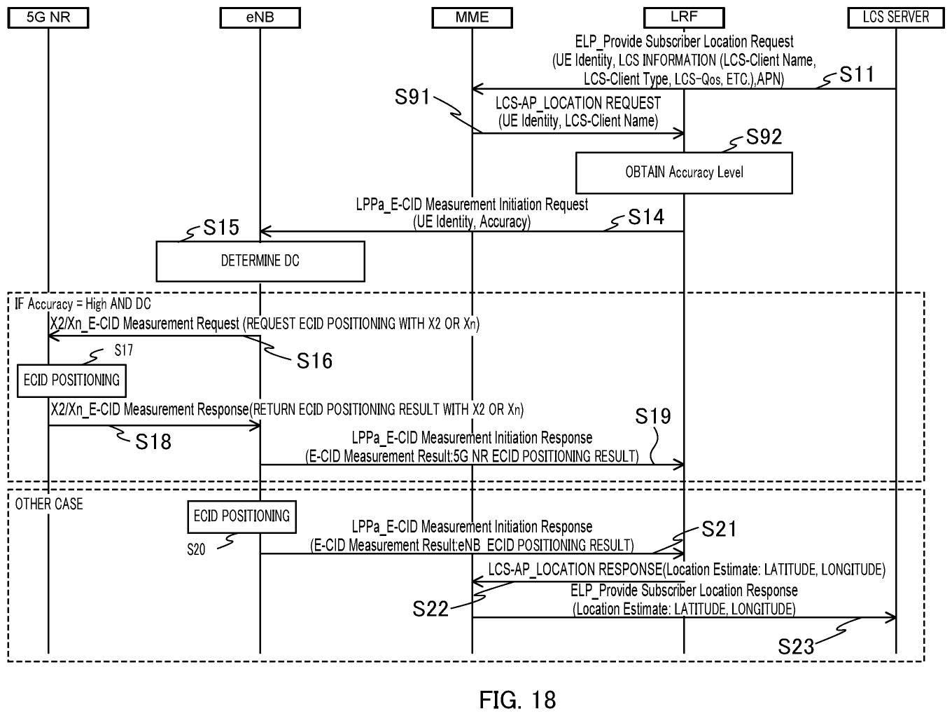

FIG. 18 is a sequence diagram illustrating an exemplary operation of the radio communication system. It is assumed that the positioning accuracy information described with reference to FIG. 17 is stored in storage section 45 of LRF 3. The process in step S11 illustrated in FIG. 18 is analogous to that in step S11 illustrated in FIG. 10. That is, request section 23 of LCS server 1 transmits ELP_Provide Subscriber Location Request to MME 2 via communication section 21.

Upon receipt of ELP_Provide Subscriber Location Request from LCS server 1 via communication section 31, request section 33 of MME 2 transmits LCS-AP_LOCATION REQUEST to LRF 3 (step S91). That is, request section 33 issues a request for obtaining the position information of user terminal 6 to LRF 3. LCS-AP_LOCATION REQUEST transmitted to LRF 3 includes UE Identity of user terminal 6 included in ELP_Provide Subscriber Location Request, and LCS-Client Name.

Next, upon receipt of LCS-AP_LOCATION REQUEST from MME 2 via communication section 41, obtaining section 43 of LRF 3 refers to the positioning accuracy information stored in storage section 45 and obtains Accuracy Level of user terminal 6 (step S92).

For example, LCS-AP_LOCATION REQUEST received from MME 2 includes LCS-Client Name of user terminal 6. Obtaining section 43 refers to the positioning accuracy information on the basis of LCS-Client Name of user terminal 6 included in LCS-AP_LOCATION REQUEST, and obtains Accuracy Level of user terminal 6.

More specifically, if LCS-Client Name is “Imadoko search,” obtaining section 43 obtains Accuracy Level “High” (see FIG. 17). If LCS-Client Name is “Current location weather,” obtaining section 43 obtains Accuracy Level “Low” (see FIG. 17).

In the processing thereafter, positioning and position calculation of user terminal 6 according to the DC of user terminal 6 and Accuracy Level are performed. That is, the following processes are analogous to the processes in steps S14 to step S23 illustrated in FIG. 10. Accordingly, the description thereof is omitted. According to the above processing, the position information of user terminal 6 is obtained according to LCS-Client Name by any one of eNB 4 and 5G NR 5.

The operation of LCS server 1 is analogous to that of the flowchart illustrated in FIG. 11. Accordingly, the description thereof is omitted. The operation of MME 2 is analogous to that of the flowchart illustrated in FIG. 12. However, the process in step S42 is different. Request section 33 of MME 2 transmits LCS-AP_LOCATION REQUEST to LRF 3 in step S42 in FIG. 12. LCS-AP_LOCATION REQUEST thereof includes LCS-Client Name received in step S41, and UE Identity of user terminal 6.

The operation of LRF 3 is analogous to that of the flowchart illustrated in FIG. 13. However, the process in step S52 is different. Obtaining section 43 of LRF 3 refers to storage section 45 on the basis of LCS-Client Name included in LCS-AP_LOCATION REQUEST received in step S51, and obtains Accuracy Level of user terminal 6.

The operation of eNB 4 is analogous to that of the flowchart illustrated in FIG. 14. Accordingly, the description thereof is omitted. The operation of 5G NR 5 is analogous to that of the flowchart illustrated in FIG. 15. Accordingly, the description thereof is omitted.

As described above, LRF 3 refers to the positioning accuracy information on the basis of LCS-Client Name of the LCS information, and obtains Accuracy Level of user terminal 6. LRF 3 transmits the obtained Accuracy Level to eNB 4. eNB 4 determines whether eNB 4 performs the ECID positioning on user terminal 6 or 5G NR 5 performs the ECID positioning on user terminal 6 on the basis of DC of user terminal 6 and Accuracy Level of user terminal 6 transmitted from LRF 3. If eNB 4 determines that 5G NR 5 is to perform the ECID positioning on user terminal 6, eNB 4 issues an ECID positioning request to 5G NR 5, and 5G NR 5 performs the ECDI positioning on user terminal 6. LRF 3 receives the positioning result from any one of eNB 4 and 5G NR 5 having performed ECID positioning, and calculates the position of user terminal 6. According to this configuration, the radio communication system can position user terminal 6 through any one of eNB 4 and 5G NR 5 according to the required accuracy of the position information.

In the above description, Accuracy Level of the user terminal is obtained on the basis of LCS-Client Name of the LCS information. Alternatively, Accuracy Level of the user terminal may be obtained on the basis of another piece of LCS information.

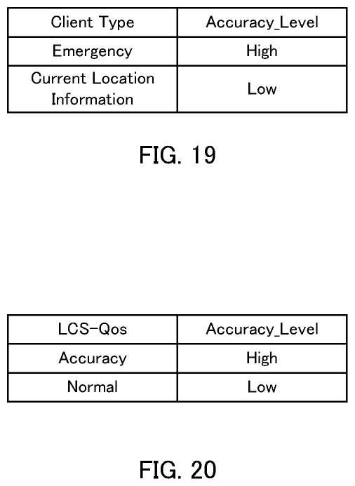

FIG. 19 illustrates another exemplary data configuration of the positioning accuracy information. As illustrated in FIG. 19, the positioning accuracy information associates Client Type with Accuracy Level. Client Type indicates LCS-Client Type of the LCS information. The positioning accuracy information is preliminarily stored in storage section 45 included in LRF 3, for example.

For example, Accuracy Level “High” is associated with Client Type of “Emergency.” “Low” is associated with Client Type of “Current Location Information.” As illustrated in FIG. 19, the positioning accuracy information may be information that associates LCS-Client Type with Accuracy Level.

FIG. 20 illustrates another exemplary data configuration of the positioning accuracy information. As illustrated in FIG. 20, the positioning accuracy information associates LCS-Qos with Accuracy Level. LCS-Qos indicates LCS-Qos of the LCS information. The positioning accuracy information is preliminarily stored in storage section 45 included in LRF 3, for example.

For example, Accuracy Level “High” is associated with LCS-Qos of “Accuracy.” Accuracy Level “Low” is associated with LCS-Qos of “Normal.” As illustrated in FIG. 20, the positioning accuracy information may be information that associates LCS-QoS with Accuracy Level.

### Embodiment 3

In Embodiment 1, Accuracy Level of the user terminal is obtained on the basis of APN. In Embodiment 2, Accuracy Level of the user terminal is obtained on the basis of LCS information. In Embodiment 3, Accuracy Level is allowed to be obtained from any of APN and the LCS information. Different parts from those in Embodiments 1 and 2 are hereinafter described. Note that the configuration of the radio communication system is analogous to that in FIG. 1.

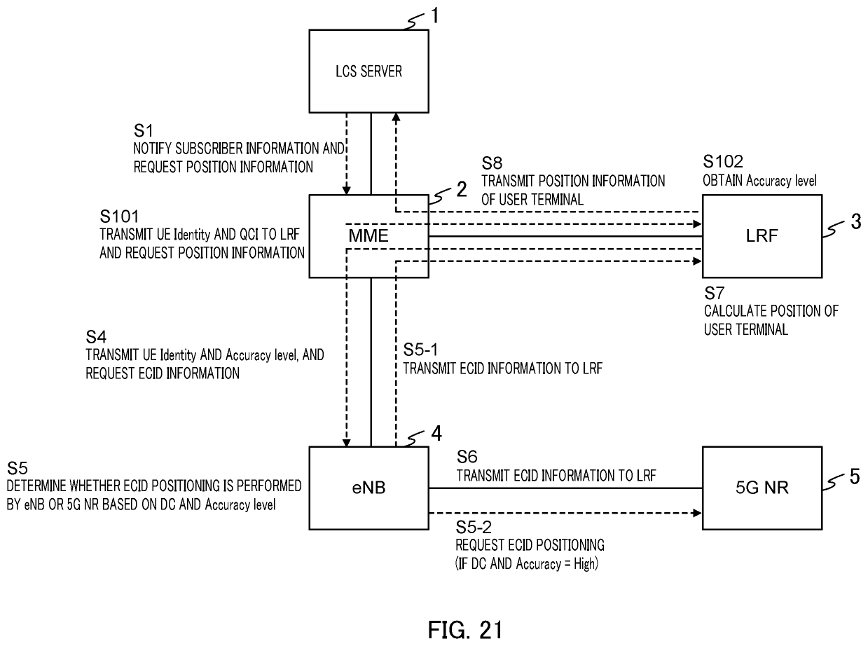

FIG. 21 illustrates a schematic operation example of the radio communication system according to Embodiment 3. The process in step S1 illustrated in FIG. 21 is analogous to that in step S1 illustrated in FIG. 3. That is, LCS server 1 requests the position information of user terminal 6 from MME 2. To request the position information, LCS server 1 transmits UE Identity of user terminal 6, APN of user terminal 6, and the LCS information to MME 2.

Upon receipt of the request for the position information issued by LCS server 1, MME 2 requests the position information of user terminal 6 from LRF 3 (step S101). To request the position information, MME 2 transmits UE Identity of user terminal 6 transmitted from LCS server 1 in step S1, and QCI (Qos Class Identifier), to LRF 3. Here, acquisition and transmission of QCI of MME 2 are described.

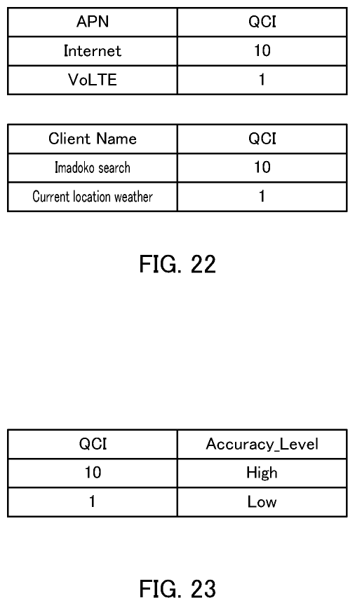

FIG. 22 illustrates an example of QCI information. As illustrated in FIG. 22, APN is associated with QCI. Client Name is associated with QCI. The QCI information illustrated in FIG. 22 is preliminarily stored in the storage apparatus of MME 2, for example.

QCI is QoS parameters that indicate the presence or absence of band limitation, delay permissible time period, packet loss and the like. The higher QCI is, the lower the band limitation is, and the shorter the delay permissible time period is. For example, QoS “10” has a lower band limitation and a shorter delay permissible time period than QoS “1” has. Consequently, for example, “Internet” that requires highly accurate position information is assigned QCI “10,” while “VoLTE” that does not require highly accurate position information is assigned QCI “1.” “Imadoko search” that requires highly accurate position information is assigned QCI “10,” while “Current location weather” that does not require highly accurate position information is assigned QCI “1.”

In the request for the position information in step S1 in FIG. 21, the LCS information and APN are transmitted from LCS server 1. MME 2 refers to the QCI information illustrated in FIG. 22 and obtains QCI on the basis of any one of the LCS information and APN transmitted from LCS server 1.

For example, it is assumed that MME 2 is configured to refer to the QCI information on the basis of APN. In this case, MME 2 refers to the QCI information and obtains the associated QCI on the basis of APN. More specifically, it is assumed that in the request for the position information in step S1 in FIG. 21, APN of “Internet” is transmitted from LCS server 1. In this case, MME 2 refers to APN of “Internet” in the QCI information illustrated in FIG. 22, and obtains QCI of “10.”

Meanwhile, for example, it is assumed that MME 2 is configured to refer to the QCI information on the basis of the LCS information. In this case, MME 2 refers to the QCI information and obtains the associated QCI on the basis of the LCS information. More specifically, it is assumed that in the request for the position information in step S1 in FIG. 21, the LCS information (LCS-Client Name) of “Current location weather” is transmitted from LCS server 1. In this case, MME 2 refers to Client Name of “Current location weather” illustrated in FIG. 22, and obtains QCI of “1.”

According to the above description, MME 2 obtains QCI from the QCI information, and transmits the QCI together with UE Identity to LRF 3.

Returning to the description with reference to FIG. 21. LRF 3 refers to the positioning accuracy information, and obtains Accuracy Level associated with QCI transmitted in step S101 (step S102).

FIG. 23 illustrates an exemplary data configuration of the positioning accuracy information. As illustrated in FIG. 23, the positioning accuracy information associates QCI with Accuracy Level. The positioning accuracy information is preliminarily stored in storage section 45 included in LRF 3, for example. LRF 3 refers to the positioning accuracy information, and obtains Accuracy Level associated with QCI transmitted in step S101.

For example, it is assumed that LRF 3 receives QCI of “10” from MME 2. In this case, LRF 3 obtains Accuracy Level “High” from the example in FIG. 23. Meanwhile, it is assumed that LRF 3 receives QCI of “1” from MME 2. In this case, LRF 3 obtains Accuracy Level “Low” from the example in FIG. 23.

In the processing thereafter, positioning and position calculation of user terminal 6 according to Accuracy Level are performed. That is, the following processes are analogous to the processes in steps S4 to step S8 illustrated in FIG. 3. Accordingly, the description thereof is omitted.

The block configuration of LCS server 1 is analogous to that in FIG. 5. Accordingly, the description thereof is omitted. The block configuration of MME 2 is analogous to that in FIG. 6, but is different in that the storage section storing the QCI information is included. The block configuration of MME 2 has a partially different function of request section 33. In the request for obtaining the position information of user terminal 6, request section 33 refers to the storage section that stores the QCI information in any one of APN and the LCS information, obtains QCI, and transmits QCI to LRF 3. The reference destination to the QCI information between APN and the LCS information can be configured by an operator, for example.

The block configuration of LRF 3 is analogous to that in FIG. 7. However, the function of obtaining section 43 is partially different. Obtaining section 43 refers to the positioning accuracy information (see FIG. 23) on the basis of QCI transmitted from MME 2, and obtains Accuracy Level of user terminal 6. Storage section 45 of LRF 3 stores the positioning accuracy information that associates QCI with Accuracy Level.

The block configuration of eNB 4 is analogous to that in FIG. 8. Accordingly, the description thereof is omitted. The block configuration of 5G NR 5 is analogous to that in FIG. 9. Accordingly, the description thereof is omitted.

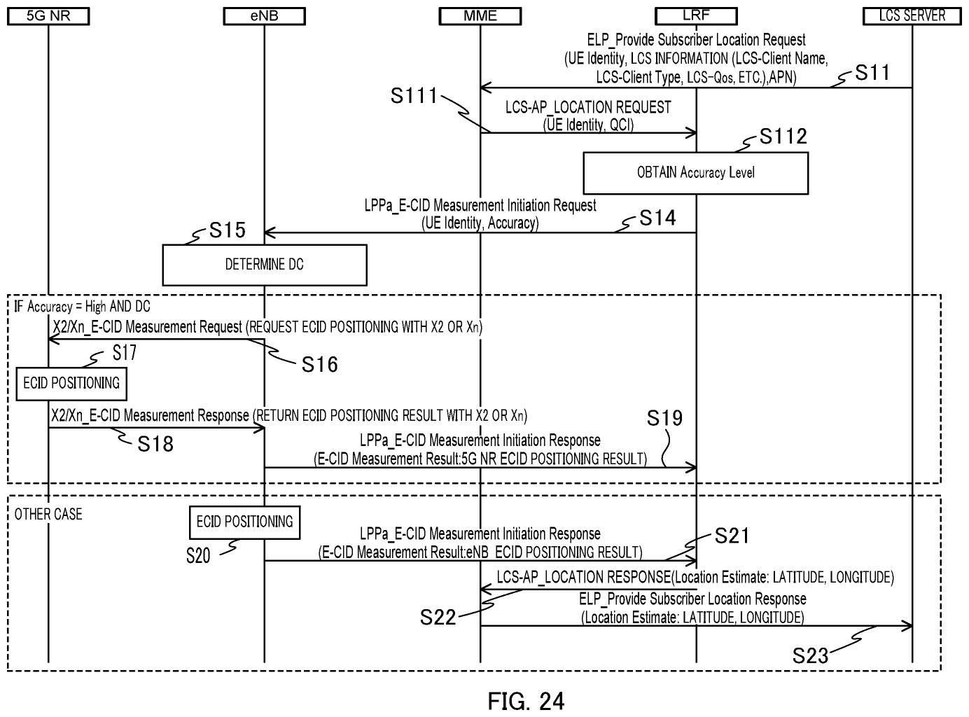

FIG. 24 is a sequence diagram illustrating an exemplary operation of the radio communication system. It is assumed that the QCI information described with reference to FIG. 22 is stored in the storage section of MME 2. It is also assumed that the positioning accuracy information described with reference to FIG. 23 is stored in storage section 45 of LRF 3. The process in step S11 illustrated in FIG. 24 is analogous to that in step S11 illustrated in FIG. 10. That is, request section 23 of LCS server 1 transmits ELP_Provide Subscriber Location Request to MME 2 via communication section 21.

Upon receipt of ELP_Provide Subscriber Location Request from LCS server 1 via communication section 31, request section 33 of MME 2 transmits LCS-AP_LOCATION REQUEST to LRF 3 (step S111). That is, request section 33 issues a request for obtaining the position information of user terminal 6 to LRF 3. LCS-AP_LOCATION REQUEST transmitted to LRF 3 includes UE Identity of user terminal 6 included in ELP_Provide Subscriber Location Request, and QCI.

Here, request section 33 of MME 2 refers to the QCI information, and obtains QCI to be transmitted to LRF 3. For example, it is assumed that request section 33 is configured to refer to the QCI information on the basis of APN. In this case, request section 33 refers to the QCI information and obtains QCI on the basis of API included in ELP_Provide Subscriber Location Request.

Meanwhile, it is assumed that request section 33 is configured to refer to the QCI information on the basis of the LCS information. In this case, request section 33 refers to the QCI information and obtains QCI on the basis of the LCS information included in ELP_Provide Subscriber Location Request.

Next, upon receipt of LCS-AP_LOCATION REQUEST from MME 2 via communication section 41, obtaining section 43 of LRF 3 refers to the positioning accuracy information stored in storage section 45 and obtains Accuracy Level of user terminal 6 (step S112).

For example, LCS-AP_LOCATION REQUEST received from MME 2 includes QCI. Obtaining section 43 refers to the positioning accuracy information on the basis of QCI included in LCS-AP_LOCATION REQUEST, and obtains Accuracy Level of user terminal 6.

More specifically, if QCI is “10,” obtaining section 43 obtains Accuracy Level “High”. If LCS-Client Name is “1,” obtaining section 43 obtains Accuracy Level “Low.”

In the processing thereafter, positioning and position calculation of user terminal 6 according to Accuracy Level are performed. That is, the following processes are analogous to the processes in steps S14 to step S23 illustrated in FIG. 10. Accordingly, the description thereof is omitted. According to the above processing, the position information of user terminal 6 is obtained according to APN of user terminal 6 or the LCS information by any one of eNB 4 and 5G NR 5.

The operation of LCS server 1 is analogous to that of the flowchart illustrated in FIG. 11. Accordingly, the description thereof is omitted. The operation of MME 2 is analogous to that of the flowchart illustrated in FIG. 12. However, the process in step S42 is different. Request section 33 of MME 2 transmits LCS-AP_LOCATION REQUEST to LRF 3 in step S42 in FIG. 12. LCS-AP_LOCATION REQUEST thereof includes QCI, and UE Identity of user terminal 6.

The operation of LRF 3 is analogous to that of the flowchart illustrated in FIG. 13. However, the process in step S52 is different. Obtaining section 43 of LRF 3 refers to storage section 45 on the basis of QCI included in LCS-AP_LOCATION REQUEST received in step S51, and obtains Accuracy Level of user terminal 6.

The operation of eNB 4 is analogous to that of the flowchart illustrated in FIG. 14. Accordingly, the description thereof is omitted. The operation of 5G NR 5 is analogous to that of the flowchart illustrated in FIG. 15. Accordingly, the description thereof is omitted.

As described above, MME 2 includes a storage section that stores QCI associated with APN, and QCI associated with Client Name of the LCS information. MME 2 obtains QCI on the basis of any one of APN and Client Name of the LCS information, which have been transmitted from LCS server 1, and transmits QCI to LRF 3. LRF 3 then obtains Accuracy Level from QCI transmitted from MME 2. According to this configuration, the radio communication system can position user terminal 6 through any one of eNB 4 and 5G NR 5 according to the required accuracy of the position information.

MME 2 converts APN into QCI, and converts Client Name into QCI. LRF 3 obtains Accuracy Level from QCI transmitted from MME 2. Consequently, LRF 3 can obtain Accuracy Level associated with APN, and obtain Accuracy Level associated with Client Name. That is, LRF 3 can obtain Accuracy Level of user terminal 6 without consciousness of APN and Client Name.

Note that in FIG. 22, Client Name is exemplified as the LCS information in QCI information, and it is assumed that Client Name is associated with QCI. However, the configuration is not limited thereto. For example, the QCI information may associate LCS-Client Name with QCI, or associate LCS-QoS with QCI.

### Embodiment 4

In Embodiment 3, QCI is obtained from APN or the LCS information, and Accuracy Level is then obtained from QCI. In Embodiment 4, QCI is obtained from APN or the LCS information, and Bearer ID associated with QCI is then obtained. Any one of eNB and 5G NR positions the user terminal on the basis of Bearer ID. Different parts from those in Embodiment 3 are hereinafter described. Note that the radio communication system is analogous to that in FIG. 1.

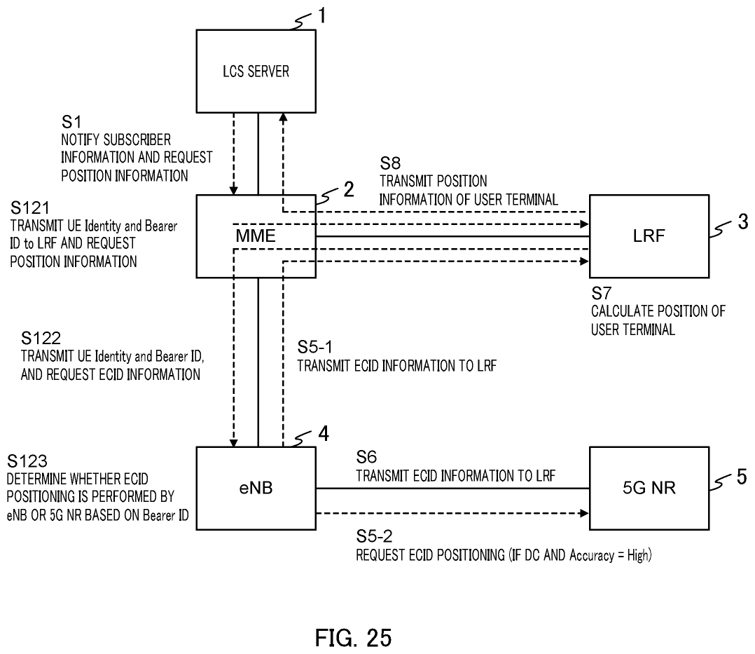

FIG. 25 illustrates a schematic operation example of the radio communication system according to Embodiment 4. The process in step S1 illustrated in FIG. 25 is analogous to that in step Si illustrated in FIG. 3. That is, LCS server 1 requests the position information of user terminal 6 from MME 2. To request the position information, LCS server 1 transmits UE Identity of user terminal 6, APN of user terminal 6, and the LCS information to MME 2.

Upon receipt of the request for the position information issued by LCS server 1, MME 2 requests the position information of user terminal 6 from LRF 3 (step S121). To request the position information, MME 2 transmits UE Identity of user terminal 6 transmitted from LCS server 1 in step S1, and Bearer ID, to LRF 3.

Bearer ID is identification information for identifying a logical packet transmission path. For example, Bearer ID “#1” indicates that user terminal 6 is served by eNB 4. That is, Bearer ID “#1” indicates that data of user terminal 6 is passed through eNB 4. Bearer ID “#2” indicates that user terminal 6 is served by 5G NR 5. That is, Bearer ID “#2” indicates that data of user terminal 6 is passed through 5G NR 5.

According to a method analogous to that described with reference to FIG. 22, MME 2 obtains QCI. MME 2 obtains Bearer ID of user terminal 6 on the basis of the obtained QCI. For example, in a case of QCI of “10,” the band limitation is low, and the delay permissible time period is short. Accordingly, Bearer ID (for example, ID=#2), which indicates serving by 5G NR 5, is obtained. On the other hand, in a case of QCI of “1,” the band limitation is high, and the delay permissible time period is long. Accordingly, Bearer ID (for example, ID=#1), which indicates serving by eNB 4, is obtained.

Next, upon receipt of the request for the position information issued by the MME, LRF 3 transmits UE Identity of user terminal 6 and Bearer ID, which have been received from MME 2, to eNB 4 via MME 2, and requests ECID information (step S122).

Next, eNB 4 determines whether ECID positioning on user terminal 6 is to be performed by eNB 4 or 5G NR 5 on the basis of Bearer ID transmitted from LRF 3 in step S122 (step S123).

For example, if Bearer ID is “#2,” eNB 4 determines that 5G NR 5 is to perform the ECID positioning on user terminal 6. On the contrary, if Bearer ID is “#1,” eNB 4 determines to perform the ECID positioning on user terminal 6 by itself.

The following processes are analogous to the processes in steps S5-1 to step S8 illustrated in FIG. 3. Accordingly, the description thereof is omitted.

The block configuration of LCS server 1 is analogous to that in FIG. 5. Accordingly, the description thereof is omitted. The block configuration of MME 2 is analogous to that of MME 2 described in Embodiment 3, but is different in that Bearer ID is obtained from QCI.

The block configuration of LRF 3 is analogous to that in FIG. 7. However, the function of obtaining section 43 is partially different. Obtaining section 43 transmits, to eNB 4, Bearer ID transmitted from MME 2.

The block configuration of eNB 4 is analogous to that in FIG. 8. However, the function of determination section 53 is partially different. Determination section 53 determines whether to allow eNB 4 to perform the ECID positioning on user terminal 6 or to allow 5G NR 5 to perform the ECID positioning on user terminal 6, on the basis of Bearer ID transmitted from LRF 3. The block configuration of 5G NR 5 is analogous to that in FIG. 9. Accordingly, the description thereof is omitted.

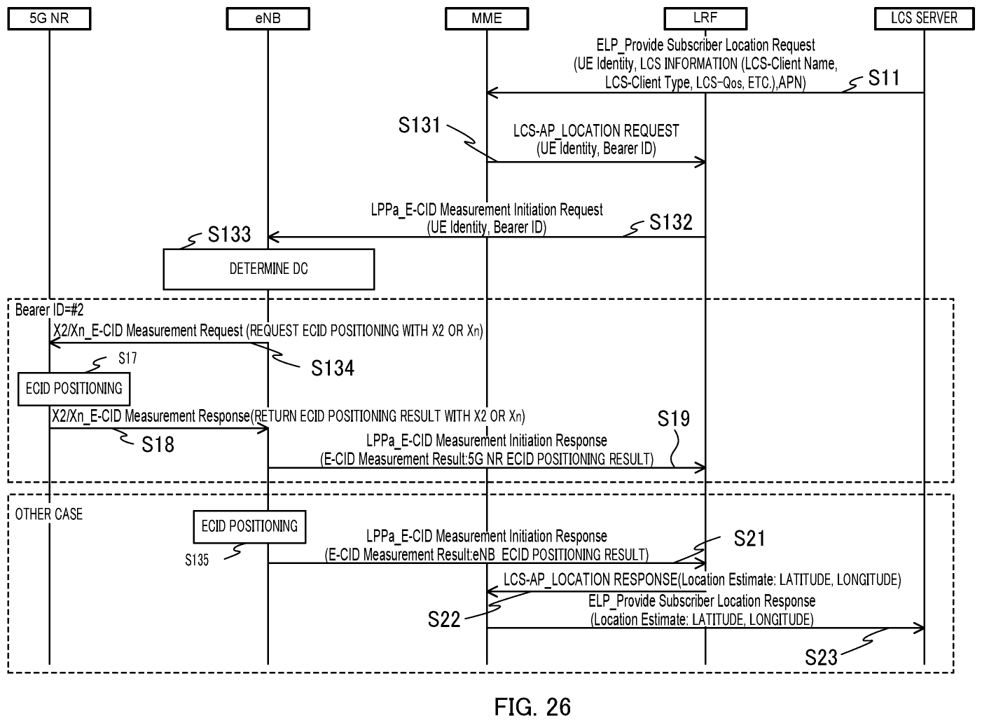

FIG. 26 is a sequence diagram illustrating an exemplary operation of the radio communication system. It is assumed that the QCI information described with reference to FIG. 22 is stored in the storage section of MME 2. The process in step S11 illustrated in FIG. 26 is analogous to that in step S11 illustrated in FIG. 10. That is, request section 23 of LCS server 1 transmits ELP_Provide Subscriber Location Request to MME 2 via communication section 21.

Upon receipt of ELP_Provide Subscriber Location Request from LCS server 1 via communication section 31, request section 33 of MME 2 transmits LCS-AP_LOCATION REQUEST to LRF 3 (step S131). That is, request section 33 issues a request for obtaining the position information of user terminal 6 to LRF 3. LCS-AP_LOCATION REQUEST transmitted to LRF 3 includes UE Identity of user terminal 6 included in ELP_Provide Subscriber Location Request, and Bearer ID.

Request section 33 of MME 2 refers to the QCI information illustrated in FIG. 22 and obtains QCI. Request section 33 obtains Bearer ID associated with the obtained QCI. For example, in the case of QCI of “10,” the band limitation is low, and the delay permissible time period is short. Accordingly, request section 33 obtains Bearer ID “#2”. For example, in the case of QCI of “1,” the band limitation is low, and the delay permissible time period is short. Accordingly, Bearer ID “#1” is obtained.

Next, when obtaining section 43 of LRF 3 obtains LCS-AP_LOCATION REQUEST from MME 2 via communication section 41, LPPa_E-CID Measurement Initiation Request is transmitted to eNB 4 (step S132). LPPa_E-CID Measurement Initiation Request transmitted to eNB 4 includes UE Identity and Bearer ID, which have been received in step S131.

Next, determination section 53 of eNB 4 determines whether user terminal 6 performs DC or not (step S133).

For example, LPPa_E-CID Measurement Initiation Request received from LRF 3 includes UE Identity of user terminal 6. Determination section 53 refers to UE Context of user terminal 6 and determines whether user terminal 6 performs DC radio communication or not on the basis of UE Identity included in LPPa_E-CID Measurement Initiation Request.

Next, if determination section 53 of eNB 4 determines that Bearer ID included in LPPa_E-CID Measurement Initiation Request received from LRF 3 is “#2,” eNB 4 transmits X2/Xn_E-CID Measurement Request to 5G NR 5 (step S134). That is, determination section 53 issues an ECID positioning request to 5G NR 5. On the other hand, if Bearer ID transmitted in step S132 is “#1,” positioning section 54 of eNB 4 performs the ECID positioning on user terminal 6 (step S135).

The following processes are analogous to the processes illustrated in FIG. 10. Accordingly, the description thereof is omitted. According to the above processing, the position information of user terminal 6 is obtained by any one of eNB 4 and 5G NR 5 according to the requested accuracy of position information, that is, APN of user terminal 6 or Bearer ID via the LCS information.

The operation of LCS server 1 is analogous to that of the flowchart illustrated in FIG. 11. Accordingly, the description thereof is omitted. The operation of MME 2 is analogous to that of the flowchart illustrated in FIG. 12. However, the process in step S42 is different. Request section 33 of MME 2 transmits LCS-AP_LOCATION REQUEST to LRF 3 in step S42 in FIG. 12. LCS-AP_LOCATION REQUEST thereof includes Bearer ID, and UE Identity of user terminal 6.

The operation of LRF 3 is analogous to that of the flowchart illustrated in FIG. 13. However, the process in step S52 is different. Obtaining section 43 of LRF 3 transmits, to eNB 4, Bearer ID included in LCS-AP_LOCATION REQUEST received in step S51, and UE Identity of user terminal 6.

The operation of eNB 4 is analogous to that of the flowchart illustrated in FIG. 14, but does not require the process in step S62, and is different in the process in step S63. After receipt of LPPa_E-CID Measurement Initiation Request from LRF 3, determination section 53 of eNB 4 determines whether Bearer ID transmitted from LRF 3 indicates serving by eNB 4 or serving by 5G NR 5. If determination section 53 determines that Bearer ID transmitted from LRF 3 indicates serving by eNB 4, the processing transitions to step S67 in FIG. 14. On the contrary, if determination section 53 determines that Bearer ID transmitted from LRF 3 indicates serving by 5G NR 5, the processing transitions to step S64 in FIG. 14. The operation of 5G NR 5 is analogous to that of the flowchart illustrated in FIG. 15. Accordingly, the description thereof is omitted.

As described above, MME 2 includes a storage section that stores QCI associated with APN, and QCI associated with Client Name of the LCS information. MME 2 obtains QCI on the basis of any one of APN and Client Name of the LCS information, which have been transmitted from LCS server 1, obtains Bearer ID associated with the obtained QCI, and transmits Bearer ID to LRF 3. LRF 3 transmits, to eNB 4, Bearer ID transmitted from MME 2. eNB 4 determines whether eNB 4 performs the ECID positioning on user terminal 6 or 5G NR 5 performs the ECID positioning on user terminal 6 on the basis of DC of user terminal 6 and Bearer ID transmitted from LRF 3. According to this configuration, the radio communication system can position user terminal 6 through any one of eNB 4 and 5G NR 5 according to the required accuracy of the position information.

The process in step S133 in FIG. 26 may be omitted. That is, in the case where eNB 4 determines whether eNB 4 performs the positioning of user terminal 6 or 5G NR 5 performs the positioning of user terminal 6, eNB 4 may omit the DC determination process.

Each embodiment has thus been described. In each embodiment, description has been made assuming 5G NR 5 as the small cell while assuming eNB 4 as the macro cell. The 5G radio base station does not necessarily support a cell covering a narrow area. The LTE radio base station does not necessarily support a cell covering a wide area. Based on the spirit of the present invention, it is only required to be capable of appropriately managing, determining and processing Accuracy Level when DC (dual connectivity) is performed by different radio base stations.

(Hardware Configuration)

The block diagrams used to describe the embodiments illustrate blocks on the basis of functions. These functional blocks (constituent sections) are implemented by any combination of hardware and/or software. A means for implementing the functional blocks is not particularly limited. That is, the functional blocks may be implemented by one physically and/or logically coupled apparatus. Two or more physically and/or logically separated apparatuses may be directly and/or indirectly (for example, via wires and/or wirelessly) connected, and the plurality of apparatuses may implement the functional blocks.

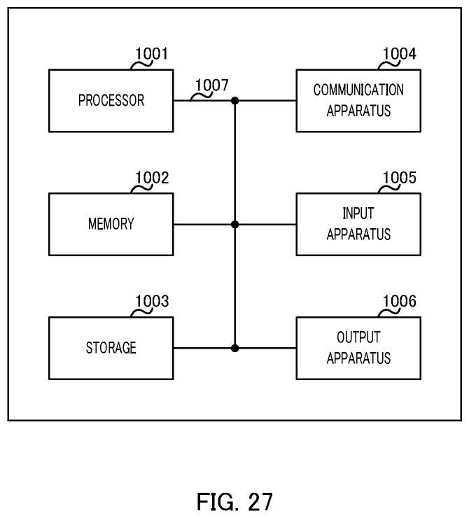

For example, each apparatus of the radio communication system according to an embodiment of the present invention may function as a computer that executes processing of the present invention. FIG. 27 illustrates an example of a hardware configuration of the LCS server, the MME, the LRF, the radio base station and the user terminal according to an embodiment of the present invention. Each apparatus as described above may be physically constituted as a computer apparatus including processor 1001, memory 1002, storage 1003, communication apparatus 1004, input apparatus 1005, output apparatus 1006, bus 1007, and the like.

Note that the term “apparatus” in the following description can be replaced with a circuit, a device, a unit, or the like. The hardware configurations of the radio base station and of the user terminal may include one apparatus or a plurality of apparatuses illustrated in the drawings or may not include part of the apparatuses.

For example, although only one processor 1001 is illustrated, there may be a plurality of processors. The processing may be executed by one processor, or the processing may be executed by one or more processors at the same time, in succession, or in another manner. Note that processor 1001 may be implemented by one or more chips.

The functions in each apparatus are implemented by predetermined software (program) loaded into hardware, such as processor 1001, memory 1002, and the like, according to which processor 1001 performs the arithmetic and controls communication performed by communication apparatus 1004 or reading and/or writing of data in memory 1002 and storage 1003.

Processor 1001 operates an operating system to entirely control the computer, for example. Processor 1001 may be composed of a central processing unit (CPU) including an interface with peripheral apparatuses, control apparatus, arithmetic apparatus, register, and the like. For example, block examples as described above may be implemented by processor 1001.

Processor 1001 reads out a program (program code), a software module, or data from storage 1003 and/or communication apparatus 1004 to memory 1002 and executes various types of processing according to the read-out program or the like. The program used is a program for causing the computer to execute at least part of the operation described in the embodiments. For example, at least some of functional blocks that constitute the respective apparatuses may be stored in memory 1002, and may be achieved by a control program operating in processor 1001. Likewise, the other functional blocks may be achieved in an analogous manner. While it has been described that the various types of processing as described above are executed by one processor 1001, the various types of processing may be executed by two or more processors 1001 at the same time or in succession. Processor 1001 may be implemented by one or more chips. Note that the program may be transmitted from a network through a telecommunication line.

Memory 1002 is a computer-readable recording medium and may be composed of, for example, at least one of a ROM (Read Only Memory), an EPROM (Erasable Programmable ROM), an EEPROM (Electrically Erasable Programmable ROM), and a RAM (Random Access Memory). Memory 1002 may be called a register, a cache, a main memory (main storage apparatus), or the like. Memory 1002 can save a program (program code), a software module, and the like that can be executed to carry out each apparatus according to an embodiment of the present invention.

Storage 1003 is a computer-readable recording medium and may be composed of, for example, at least one of an optical disk such as a CD-ROM (Compact Disc ROM), a hard disk drive, a flexible disk, a magneto-optical disk (for example, a compact disc, a digital versatile disc, or a Blue-ray (registered trademark) disc), a smart card, a flash memory (for example, a card, a stick, or a key drive), a floppy (registered trademark) disk, and a magnetic strip. Storage 1003 may also be called an auxiliary storage apparatus. The storage medium as described above may be a database, server, or other appropriate media including memory 1002 and/or storage 1003.

Communication apparatus 1004 is hardware (transmission and reception device) for communication between computers through a wired and/or wireless network and is also called, for example, a network device, a network controller, a network card, or a communication module.

Input apparatus 1005 is an input device (for example, a keyboard, a mouse, a microphone, a switch, a button, or a sensor) that receives input from the outside. Output apparatus 1006 is an output device (for example, a display, a speaker, or an LED lamp) which outputs to the outside. Note that input apparatus 1005 and output apparatus 1006 may be integrated (for example, a touch panel).

The apparatuses, such as processor 1001 and memory 1002, are connected by bus 1007 for communication of information. Bus 1007 may be composed of a single bus or by buses different among the apparatuses.

Furthermore, each apparatus may include hardware, such as a microprocessor, a digital signal processor (DSP), an Application Specific Integrated Circuit (ASIC), a Programmable Logic Device (PLD), and a Field Programmable Gate Array (FPGA), and the hardware may implement part or all of the functional blocks. For example, processor 1001 may be implemented by at least one of these pieces of hardware.

(Notification and Signaling of Information)

The notification of information is not limited to the aspects or embodiments described in the present specification, and the information may be notified by another method. For example, the notification of information may be carried out by one or a combination of physical layer signaling (for example, DCI (Downlink Control Information) and UCI (Uplink Control Information)), higher layer signaling (for example, RRC (Radio Resource Control) signaling, MAC (Medium Access Control) signaling, broadcast information (MIB (Master Information Block), and SIB (System Information Block))), and other signals. The RRC signaling may be called an RRC message and may be, for example, an RRC connection setup message, an RRC connection reconfiguration message, or the like.

(Adaptive System)

The aspects and embodiments described in the present specification may be applied to a system using LTE (Long Term Evolution), LTE-A (LTE-Advanced), SUPER 3G, IMT-Advanced, 4G, 5G, FRA (Future Radio Access), W-CDMA (registered trademark), GSM (registered trademark), CDMA2000, UMB (Ultra Mobile Broadband), IEEE 802.11 (Wi-Fi), IEEE 802.16 (WiMAX), IEEE 802.20, UWB (Ultra-WideBand), Bluetooth (registered trademark), or other appropriate systems and/or to a next-generation system extended based on the above systems.

(Processing Procedure and the Like)

The orders of the processing procedures, the sequences, the flow charts, and the like of the aspects and embodiments described in the present specification may be changed as long as there is no contradiction. For example, elements of various steps are presented in exemplary orders in the methods described in the present specification, and the methods are not limited to the presented specific orders.

(Operation of Base Station)

Specific operations which are described in the specification as being performed by the base station (radio base station) may sometimes be performed by an upper node depending on the situation. Various operations performed for communication with a terminal in a network including one network node or a plurality of network nodes including a base station can be obviously performed by the base station and/or a network node other than the base station (examples include, but not limited to, MME (Mobility Management Entity) or S-GW (Serving Gateway)). Although there is one network node in addition to the base station in the case illustrated above, a plurality of other network nodes may be combined (for example, MME and S-GW).

(Direction of Input and Output)

The information, the signals, and the like can be output from a higher layer (or a lower layer) to a lower layer (or a higher layer). The information, the signals, and the like may be input and output through a plurality of network nodes.

(Handling of Input and Output Information and the Like)

The input and output information and the like may be saved in a specific place (for example, memory) or may be managed by a management table. The input and output information and the like can be overwritten, updated, or additionally written. The output information and the like may be deleted. The input information and the like may be transmitted to another apparatus.

(Determination Method)

The determination may be made based on a value expressed by one bit (0 or 1), based on a Boolean value (true or false), or based on comparison with a numerical value (for example, comparison with a predetermined value).

(Software)

Regardless of whether the software is called software, firmware, middleware, a microcode, or a hardware description language or by another name, the software should be broadly interpreted to mean an instruction, an instruction set, a code, a code segment, a program code, a program, a subprogram, a software module, an application, a software application, a software package, a routine, a subroutine, an object, an executable file, an execution thread, a procedure, a function, and the like.

The software, the instruction, and the like may be transmitted and received through a transmission medium. For example, when the software is transmitted from a website, a server, or another remote source by using a wired technique, such as a coaxial cable, an optical fiber cable, a twisted pair, and a digital subscriber line (DSL), and/or a wireless technique, such as an infrared ray, a radio wave, and a microwave, the wired technique and/or the wireless technique is included in the definition of the transmission medium.

(Information and Signals)

The information, the signals, and the like described in the present specification may be expressed by using any of various different techniques. For example, data, instructions, commands, information, signals, bits, symbols, chips, and the like that may be mentioned throughout the entire description may be expressed by one or an arbitrary combination of voltage, current, electromagnetic waves, magnetic fields, magnetic particles, optical fields, and photons.

Note that the terms described in the present specification and/or the terms necessary to understand the present specification may be replaced with terms with the same or similar meaning. For example, the channel and/or the symbol may be a signal. The signal may be a message. The component carrier (CC) may be called a carrier frequency, a cell, or the like.

(“System” and “Network”)

The terms “system” and “network” used in the present specification can be interchangeably used.

(Names of Parameters and Channels)

The information, the parameters, and the like described in the present specification may be expressed by absolute values, by values relative to predetermined values, or by other corresponding information. For example, radio resources may be indicated by indices.

The names used for the parameters are not limited in any respect. Furthermore, the numerical formulas and the like using the parameters may be different from the ones explicitly disclosed in the present specification. Various channels (for example, PUCCH and PDCCH) and information elements (for example, TPC) can be identified by any suitable names, and various names assigned to these various channels and information elements are not limited in any respect.

(Base Station)

The base station (radio base station) can accommodate one cell or a plurality of (for example, three) cells (also called sector). When the base station accommodates a plurality of cells, the entire coverage area of the base station can be divided into a plurality of smaller areas, and each of the smaller areas can provide a communication service based on a base station subsystem (for example, small base station for indoor, remote radio head (RRH)). The term “cell” or “sector” denotes part or all of the coverage area of the base station and/or of the base station subsystem that perform the communication service in the coverage. Furthermore, the terms “base station,” “eNB,” “cell,” and “sector” can be interchangeably used in the present specification. The base station may be called a fixed station, a NodeB, an eNodeB (eNB), an access point, a femto cell, a small cell, or the like.

(Terminal)

The user terminal may be called, by those skilled in the art, a mobile station, a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or UE (User Equipment) or by some other appropriate terms.

(Meaning and Interpretation of Terms)

As used herein, the term “determining” may encompass a wide variety of actions. For example, “determining” may be regarded as judging, calculating, computing, processing, deriving, investigating, looking up (for example, looking up in a table, a database or another data structure), ascertaining and the like. Also, “determining” may be regarded as receiving (for example, receiving information), transmitting (for example, transmitting information), inputting, outputting, accessing (for example, accessing data in a memory) and the like. Also, “determining” may be regarded as resolving, selecting, choosing, establishing and the like. That is, “determining” may be regarded as a certain type of action related to determining.

The terms “connected” and “coupled” as well as any modifications of the terms mean any direct or indirect connection and coupling between two or more elements, and the terms can include cases in which one or more intermediate elements exist between two “connected” or “coupled” elements. The coupling or the connection between elements may be physical or logical coupling or connection or may be a combination of physical and logical coupling or connection. When the terms are used in the present specification, two elements can be considered to be “connected” or “coupled” to each other by using one or more electrical wires, cables, and/or printed electrical connections or by using electromagnetic energy, such as electromagnetic energy with a wavelength of a radio frequency domain, a microwave domain, or an optical (both visible and invisible) domain that are non-limiting and non-inclusive examples.

The reference signal can also be abbreviated as RS and may also be called a pilot depending on the applied standard. The correction RS may be called a TRS (Tracking RS), a PC-RS (Phase Compensation RS), a PTRS (Phase Tracking RS), or an additional RS. The demodulation RS and the correction RS may be called by other corresponding names, respectively. The demodulation RS and the correction RS may be specified by the same name (for example, demodulation RS).

The description “based on” used in the present specification does not mean “based only on,” unless otherwise specifically stated. In other words, the description “based on” means both of “based only on” and “based at least on.”

The “section” in the configuration of each apparatus may be replaced with “means,” “circuit,” “device,” or the like.

The terms “including,” “comprising,” and modifications of these terms are intended to be inclusive just like the term “having,” as long as the terms are used in the present specification or the appended claims. Furthermore, the term “or” used in the present specification or the appended claims is not intended to be an exclusive or.

The radio frame may be constituted by one frame or a plurality of frames in the time domain. The one frame or each of the plurality of frames may be called a subframe, a time unit, or the like in the time domain. The subframe may be further constituted by one slot or a plurality of slots in the time domain. The slot may be further constituted by one symbol or a plurality of symbols (OFDM (Orthogonal Frequency Division Multiplexing) symbol, SC-FDMA (Single Carrier-Frequency Division Multiple Access) symbol, or the like) in the time domain.

The radio frame, the subframe, the slot, and the symbol indicate time units in transmitting signals. The radio frame, the subframe, the slot, and the symbol may be called by other corresponding names.

For example, in the LTE system, the base station creates a schedule for assigning radio resources to each mobile station (such as frequency bandwidth that can be used by each mobile station and transmission power). The minimum time unit of scheduling may be called a TTI (Transmission Time Interval).

For example, one subframe, a plurality of continuous subframes, or one slot may be called a TTI.

The resource unit is a resource assignment unit in the time domain and the frequency domain, and the resource unit may include one subcarrier or a plurality of continuous subcarriers in the frequency domain. In addition, the resource unit may include one symbol or a plurality of symbols in the time domain, and may have a length of one slot, one subframe, or one TTI. One TTI and one subframe may be constituted by one resource unit or a plurality of resource units. The resource unit may be called a resource block (RB), a physical resource block (PRB: Physical RB), a PRB pair, an RB pair, a scheduling unit, a frequency unit, or a subband. The resource unit may be constituted by one RE or a plurality of REs. For example, one RE only has to be a resource smaller in unit size than the resource unit serving as a resource assignment unit (for example, one RE only has to be a minimum unit of resource), and the naming is not limited to RE.

The structure of the radio frame is illustrative only, and the number of subframes included in the radio frame, the number of slots included in the subframe, the numbers of symbols and resource blocks included in the slot, and the number of subcarriers included in the resource block can be changed in various ways.

When articles, such as “a,” “an,” and “the” in English, are added by translation in the entire disclosure, the articles include plural forms unless otherwise clearly indicated by the context.

(Variations and the Like of Aspects)

The aspects and embodiments described in the present specification may be independently used, may be used in combination, or may be switched and used along the execution. Furthermore, notification of predetermined information (for example, notification indicating “it is X”) is not limited to explicit notification, and may be performed implicitly (for example, by not notifying the predetermined information).

While the present invention has been described in detail, it is obvious to those skilled in the art that the present invention is not limited to the embodiments described in the present specification. Modifications and variations of the aspects of the present invention can be made without departing from the spirit and the scope of the present invention defined by the description of the appended claims. Therefore, the description of the present specification is intended for exemplary description and does not limit the present invention in any sense.

### INDUSTRIAL APPLICABILITY

An aspect of the present invention is useful for a mobile communication system.

The present patent application claims the benefit of priority based on Japanese Patent Application No. 2017-155510 filed on Aug. 10, 2017, and the entire content of Japanese Patent Application No. 2017-155510 is hereby incorporated by reference.

### REFERENCE SIGNS LIST

1 LCS Server
2 MME
3 LRF
4 eNB
5 5G NR
6 User Terminal
21, 31, 41, 51, 61 Communication Section
22, 32, 42, 52, 62 Call Processing Section
23, 33 Request Section
43 Obtaining Section
44 Calculation Section
45 Storage Section
53 Determination Section
54, 63 Positioning Section

1. A position calculation apparatus that calculates a position of a user terminal in DC (dual connectivity) with a first radio base station and a second radio base station, the position calculation apparatus comprising:
a transmission section that transmits accuracy level information to the first radio base station, the accuracy level information indicating a positioning accuracy of the user terminal based on a type of a service provided for the user terminal;
a reception section that receives, from the first radio base station, positioning information indicating a result of positioning of the user terminal performed by the first radio base station when the accuracy level information indicates a first accuracy level, and that receives, from the first radio base station, positioning information indicating a result of positioning of the user terminal performed by the second radio base station when the accuracy level information indicates a second accuracy level having a higher accuracy than the first accuracy level has; and
a position calculation section that calculates the position of the user terminal, using the positioning information received by the reception section.

2. The position calculation apparatus according to claim 1, wherein the type of the service is any of a service related to an access point name, a location service, or a service related to a quality identifier for identifying a communication service quality.

3. The position calculation apparatus according to claim 2, wherein the service related to the quality identifier is one converted by a base station management apparatus from any one of the service related to the access point name, and the location service, and is transmitted from the base station management apparatus.

4. A position calculation apparatus that calculates a position of a user terminal in DC (dual connectivity) with a first radio base station and a second radio base station, the position calculation apparatus comprising:
a reception section that receives, from a base station management apparatus, first bearer information indicating that data on the user terminal is passed through the first radio base station, or second bearer information indicating that data on the user terminal is passed through the second radio base station;
a transmission section that transmits, to the first radio base station, the first bearer information or the second bearer information received by the reception section;
a positioning information reception section that receives, from the first radio base station, positioning information indicating a result of positioning of the user terminal performed by the first radio base station when the first bearer information is transmitted, and receives, from the first radio base station, positioning information indicating a result of positioning of the user terminal performed by the second radio base station when the second bearer information is transmitted; and
a position calculation section that calculates the position of the user terminal, using the positioning information received by the positioning information reception section.

5. A radio base station cooperating with another radio base station to perform DC (dual connectivity) with a user terminal, the radio base station comprising:
a reception section that receives accuracy level information indicating positioning of the user terminal, from a position calculation apparatus that calculates a position of the user terminal; and
a transmission section that transmits, to the position calculation apparatus, positioning information indicating a result of positioning of the user terminal performed by the radio base station when the accuracy level information indicates a first accuracy level, and transmits, to the position calculation apparatus, positioning information indicating a result of positioning of the user terminal performed by the other radio base station when the accuracy level information indicates a second accuracy level having a higher accuracy than the first accuracy level has.

6. A radio base station cooperating with another radio base station to perform DC (dual connectivity) with a user terminal, the radio base station comprising:
a reception section that receives, from a position calculation apparatus that calculates a position of the user terminal, first bearer information indicating that data on the user terminal is passed through the first radio base station, or second bearer information indicating that data on the user terminal is passed through the second radio base station; and
a transmission section that transmits, to the position calculation apparatus, positioning information indicating a result of positioning of the user terminal performed by the radio base station when the first bearer information is received, and transmits, to the second radio base station, positioning information indicating a result of positioning of the user terminal performed by the other radio base station when the second bearer information is received.

7. A position calculation method for calculating a position of a user terminal in DC (dual connectivity) with a first radio base station and a second radio base station, the position calculation method comprising:
transmitting accuracy level information to the first radio base station, the accuracy level information indicating a positioning accuracy of the user terminal based on a type of a service provided for the user terminal;
receiving, from the first radio base station, positioning information indicating a result of positioning of the user terminal performed by the first radio base station when the accuracy level information indicates a first accuracy level, and receiving, from the first radio base station, positioning information indicating a result of positioning of the user terminal performed by the second radio base station when the accuracy level information indicates a second accuracy level having a higher accuracy than the first accuracy level has; and
calculating the position of the user terminal using the received positioning information.

8. A position calculation method for calculating a position of a user terminal in DC (dual connectivity) with a first radio base station and a second radio base station, the position calculation method comprising:
receiving, from a base station management apparatus, first bearer information indicating that data on the user terminal is passed through the first radio base station, or second bearer information indicating that data on the user terminal is passed through the second radio base station;
transmitting, to the first radio base station, the first bearer information or the second bearer information received;
receiving, from the first radio base station, positioning information indicating a result of positioning of the user terminal performed by the first radio base station when the first bearer information is transmitted, and receiving, from the first radio base station, positioning information indicating a result of positioning of the user terminal performed by the second radio base station when the second bearer information is transmitted; and
calculating the position of the user terminal, using the received positioning information.

9. A positioning control method of a radio base station cooperating with another radio base station to perform DC (dual connectivity) with a user terminal, the positioning control method comprising:
receiving accuracy level information indicating positioning of the user terminal, from a position calculation apparatus that calculates a position of the user terminal; and
transmitting, to the position calculation apparatus, positioning information indicating a result of positioning of the user terminal performed by the radio base station when the accuracy level information indicates a first accuracy level, and transmitting, to the position calculation apparatus, positioning information indicating a result of positioning of the user terminal performed by the other radio base station when the accuracy level information indicates a second accuracy level having a higher accuracy than the first accuracy level has.

10. A positioning control method of a radio base station cooperating with another radio base station to perform DC (dual connectivity) with a user terminal, the positioning control method comprising:
receiving, from a position calculation apparatus that calculates a position of the user terminal, first bearer information indicating that data on the user terminal is passed through the first radio base station, or second bearer information indicating that data on the user terminal is passed through the second radio base station; and
transmitting, to the position calculation apparatus, positioning information indicating a result of positioning of the user terminal performed by the radio base station when the first bearer information is received, and transmitting, to the second radio base station, positioning information indicating a result of positioning of the user terminal performed by the other radio base station when the second bearer information is received.
